(19) United States
(12) Patent Application Publication
(10) Pub. No.: US 2018/0033089 A1
(43) Pub. Date: Feb. 1, 2018

(54) METHOD AND SYSTEM FOR IDENTIFYING AND ADDRESSING POTENTIAL ACCOUNT TAKEOVER ACTIVITY IN A FINANCIAL SYSTEM

(71) Applicant: Intuit Inc., Mountain View, CA (US)

(72) Inventors: Jonathan R. Goldman, Mountain View, CA (US); Monica Tremont Hsu, Burlingame, CA (US); Efraim Feinstein, Palo Alto, CA (US); Thomas M. Pigoski, II, San Francisco, CA (US)

(73) Assignee: Intuit Inc., Mountain View, CA (US)

(21) Appl. No.: 15/220,623

(22) Filed: Jul. 27, 2016

(51) Int. Cl. G06Q 40/00; H04L 29/06

(52) U.S. Cl. CPC G06Q 40/10; H04L 63/102; H04L 63/083

(57) ABSTRACT

Account takeover is one of a number of types of Internet-centric crime (i.e., cybercrime) that includes the unauthorized access/use of a user's account with the user's identity or credentials (e.g., username and/or password). Because fraudsters acquire user credentials through phishing, spyware, or malware scams, it can be difficult to detect unauthorized access of a user's account. Methods and systems of the present disclosure identify and address potential account takeover activity, according to one embodiment. The methods and systems acquire system access data, apply the system access data to one or more predictive models to generate one or more risk scores, and perform one or more risk reduction actions based on the one or more risk scores, according to one embodiment. The financial system is a tax return preparation system according to one embodiment.

### BACKGROUND

Financial services are diverse and valuable tools, providing services that were either never before available, or were previously available only through interaction with a human professional. For example, a financial service may provide tax preparation or financial management services. Prior to the advent of financial services, a user would be required to consult with a tax preparation or financial management professional for services and the user would be limited, and potentially inconvenienced, by the hours during which the professional was available for consultation. Furthermore, the user might be required to travel to the professional's physical location. Beyond the inconveniences of scheduling and travel, the user would also be at the mercy of the professional's education, skill, personality, and varying moods. All of these factors resulted in a user who was vulnerable to human error, variations in human ability, and variations in human temperament.

Some financial systems provide services that human professionals are not capable of providing, and even those financial systems that provide services that are similar to services that have historically been provided by human professionals offer many benefits, such as: not having limited working hours, not being geographically limited, and not being subject to human error or variations in human ability or temperament. Because financial systems represent a potentially flexible, highly accessible, and affordable source of services, they have the potential of attracting both positive and negative attention.

Fraudsters (cybercriminals) target financial systems to obtain money or financial credit using a variety of unethical techniques. For example, fraudsters can target tax return preparation systems to obtain tax refunds and/or tax credits based on legitimate and/or illegitimate information for legitimate users. As a specific example of fraudulent activity against a tax return preparation system, a gang of fraudsters could coordinate resources to steal millions of dollars in tax refunds during a single tax season. Such an experience can be traumatic for current tax return preparation system users and can have a chilling effect on potential future users of the tax return preparation system. Such security risks are bad for tax filers and can damage relations between tax filers and tax preparation service providers.

Fraudsters can use account take over (ATO) as one technique for stealing from people. In ATO, fraudsters steal identities through phishing attacks (e.g., through deceitful links in email messages) or by purchasing identities using identity theft services in underground markets. Because fraudsters acquire user identities and/or credentials from sources that are external to and unrelated to financial systems, the financial systems are historically not able to prevent fraudsters from accessing and using other peoples' (victims') accounts. While service providers want to protect their customers, the fraudsters are unfortunately using legitimate identity information to hack into users' financial system accounts. If financial systems have to block legitimate login credentials, how can anyone receive service providers' services? What's more, as cybercrime is proved repeatedly successful, this Internet-centric problem can only grow worse (e.g., more popular to criminals).

Potential account takeover and other cybercriminal activity hurts users and hurts the service providers that work to make users' lives more manageable by providing financial services. What is needed is a method and system for identifying and addressing potential account takeover activity in a financial system, according to one embodiment.

### SUMMARY

Account takeover is a terrible crime. It is one of a number of types of Internet-centric crime (i.e., cybercrime) that includes unauthorized access of a user's account with use of the user's personally identifiable information or credentials (e.g., username and/or password). Cybercriminals (a.k.a., fraudsters) typically access accounts that are associated with a financial service in order to access personal information, access financial information, and/or acquire current or future monies of victims. Because fraudsters acquire user credentials through phishing, spyware, or malware scams, fraudsters are acquiring user credentials directly from the unsuspecting users/victims. In the case of tax return preparation systems, fraudsters login as users and attempt to direct tax refunds away from the rightful recipients and into one or more fraudsters' accounts. Although service providers of financial systems are not contributing to the fraudulent activity, the service providers of the financial systems work to protect their customers' financial interests. The systems and methods of the present disclosure provide techniques for identifying and addressing potential fraud by account takeover in a financial system to protect users' accounts, even if users have unwittingly provided fraudsters with the users' account credentials, according to one embodiment.

The present disclosure includes methods and systems for identifying and addressing potentially fraudulent (e.g., account takeover) activity in a financial system, according to one embodiment. To identify and address the potential fraudulent activity, a security system: receives system access data for a user account, generates one or more risk scores based on the system access data, and performs one or more risk reduction actions based on the likelihood of potential fraud that is represented by the one or more risk scores, according to one embodiment.

The system access data includes information associated with a user interacting with the financial system, according to one embodiment. The system access data represents system access activities of one or more users with the financial system, according to one embodiment. The system access data includes, but is not limited to, number of user experience pages visited in the financial system, identification of the computing system used to access the financial system, an Internet browser and/or an operating system of the computing system used to access the financial system, clickstream data generated while accessing the financial system, Internet Protocol (“IP”) address characteristics of the computing system used to access the financial system, and the like. Additional examples of system access data and/or system access activities are provided below.

The one or more risk scores individually and/or cumulatively represent a likelihood of potential fraudulent activity in a user session with the financial system, according to one embodiment. Each user session is associated with a subset of the system access data stored/maintained by the financial systems and/or the security system, according to one embodiment. The security system processes the system access data to determine various types of risk scores, according to one embodiment. The one or more risk scores include risk scores for risk categories such as: an IP address of a user computing system used to access the financial system, user system characteristics of a user computing system used to access the financial system, and an account of a user for the financial system, according to one embodiment.

The security system generates the one or more risk scores using one or more predictive models that are trained to identify potentially fraudulent activity, according to one embodiment. The one or more predictive models are trained using system access data that has been associated with fraudulent activity, which enables the one or more predictive models to generate scores that represent the likelihood of fraudulent activity based on analysis of prior cases, according to one embodiment.

The risk reduction actions include one or more techniques for protecting a user's account and/or the user of the financial system from unauthorized use of the user's account, according to one embodiment. Examples of the risk reduction actions include, but are not limited to, preventing a user (e.g., a fraudster) from taking an action within the financial system, preventing a user from logging into the financial system, making it more difficult for a user to log into the financial system, adding additional factors to multifactor authentication procedures for logging into the financial system, alerting a user of potential fraudulent activity associated with the user's account, temporarily suspending a tax return filing, and the like, according to one embodiment. Additional embodiments of risk reduction actions are disclosed in more detail below.

The security system generates the one or more risk scores and performs the one or more risk reduction actions based on information that is in addition to the system access data, according to one embodiment. In one embodiment, the security system uses one or more of IP address characteristics, user computing system characteristics/identification, forensic computing system data, and/or user account data (e.g., an account identifier), according to one embodiment.

The security system works with the financial system to identify and address the potentially fraudulent activity, according to one embodiment. In one embodiment, the functionality/features of the security system are integrated into the financial system. In one embodiment, the security system shares one or more resources with the financial system in a service provider computing environment. In one embodiment, the security system requests the information that is used for identification of potentially fraudulent activity from the financial system. In one embodiment, the financial system is one of: a tax return preparation system, a personal financial management system, and a business financial management system.

These and other embodiments of the tax return preparation system are discussed in further detail below.

By identifying and addressing potentially fraudulent activity (e.g., account takeover) in a financial system, implementation of embodiments of the present disclosure allows for significant improvement to the fields of data security, financial systems security, electronic tax return preparation, data collection, and data processing, according to one embodiment. As illustrative examples, by identifying and addressing potentially fraudulent activity, fraudsters can be deterred from criminal activity, financial system providers may retain/build trusting relationships with customers, customers may be spared financial losses, criminally funded activities may be decreased due to less or lack of funding, and tax refunds may be delivered to authorized recipients faster (due to less likelihood of unauthorized recipients). As another example, by identifying and implementing risk reducing actions, tax filer complaints to the Internal Revenue Service (“IRS”) and to financial system service providers may be reduced. As a result, embodiments of the present disclosure allow for reduced communication channel bandwidth utilization and faster communications connections. Consequently, computing and communication systems implementing and/or providing the embodiments of the present disclosure are transformed into faster and more operationally efficient devices and systems.

In addition to improving overall computing performance, by identifying and addressing potentially fraudulent activity in a financial system, implementation of embodiments of the present disclosure represent a significant improvement to the field of providing an efficient user experience and, in particular, efficient use of human and non-human resources. As one illustrative example, by identifying and addressing fraudulent activity in user accounts, users can devote less time and energy to resolving issues associated with account abuse. Additionally, by identifying and addressing potential account takeover activity in a financial system, the financial system maintains, improves, and/or increases the likelihood that a customer will remain a paying customer and advertise the received services to the customer's peers, according to one embodiment. Consequently, using embodiments of the present disclosure, the user's experience is less burdensome and time consuming and allows the user to dedicate more of his or her time to other activities or endeavors.

### BRIEF DESCRIPTION OF THE DRAWINGS

FIG. 1 is a block diagram of software architecture for identifying and addressing potential account takeover activity in a financial system, in accordance with one embodiment.

FIG. 2 is a block diagram of software architecture for identifying and addressing potential account takeover activity in a tax return preparation system, in accordance with one embodiment.

FIG. 3 is a flow diagram of a process for identifying and addressing potential account takeover activity in a tax return preparation system, according to one embodiment.

FIG. 4 is a flow diagram of a process for training one or more predictive models for identifying potential account takeover activity in a tax return preparation system, according to one embodiment.

FIG. 5 is a flow diagram for identifying and addressing potential account takeover activity in a financial system, in accordance with one embodiment.

FIG. 6 is a flow diagram for identifying and addressing potential account takeover activity in a financial system, in accordance with one embodiment.

FIGS. 7A and 7B are a flow diagram for identifying and addressing potential account takeover activity in a financial system, in accordance with one embodiment.

FIGS. 8A and 8B are a flow diagram for identifying and addressing potential account takeover activity in a financial system, in accordance with one embodiment.

Common reference numerals are used throughout the FIGS. and the detailed description to indicate like elements. One skilled in the art will readily recognize that the above FIGS. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be implemented in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for identifying and addressing potential account takeover activity in a financial system, according to various embodiments.

### Introductory System

Herein, a system (e.g., a software system) can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data.

As used herein, the term system includes, but is not limited to the following: computing system implemented, and/or online, and/or web-based, personal and/or business tax preparation systems; computing system implemented, and/or online, and/or web-based, personal and/or business financial management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of systems include, but are not limited to the following: TurboTax® available from Intuit, Inc. of Mountain View, Calif.; TurboTax® Online available from Intuit, Inc. of Mountain View, Calif.; QuickBooks®, available from Intuit, Inc. of Mountain View, Calif.; QuickBooks® Online, available from Intuit, Inc. of Mountain View, Calif.; Mint®, available from Intuit, Inc. of Mountain View, Calif.; Mint® Online, available from Intuit, Inc. of Mountain View, Calif.; and/or various other systems discussed herein, and/or known to those of skill in the art at the time of filing, and/or as developed after the time of filing. In one embodiment, data collected from users of TurboTax® and/or TurboTax® Online is not used with other service provider systems, such as Mint® or QuickBooks®.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given system as that system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the system in the production environment such as a data center, a cloud computing environment, a dedicated hosting environment, and/or one or more other computing environments in which one or more assets used by the application in the production environment are implemented; one or more computing systems or computing entities used to implement at least part of the system in the production environment; one or more virtual assets used to implement at least part of the system in the production environment; one or more supervisory or control systems, such as hypervisors, or other monitoring and management systems used to monitor and control assets and/or components of the production environment; one or more communications channels for sending and receiving data used to implement at least part of the system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the system in the production environment; one or more databases used to store data in the production environment; one or more internal or external services used to implement at least part of the system in the production environment; one or more backend systems, such as backend servers or other hardware used to process data and implement at least part of the system in the production environment; one or more modules/functions used to implement at least part of the system in the production environment; and/or any other assets/components making up an actual production environment in which at least part of the system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the system.

In various embodiments, one or more cloud computing environments are used to create, and/or deploy, and/or operate at least part of the system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience display” includes not only data entry and question submission user interfaces, but also other user experience features and elements provided or displayed to the user such as, but not limited to the following: data entry fields, question quality indicators, images, backgrounds, avatars, highlighting mechanisms, icons, buttons, controls, menus and any other features that individually, or in combination, create a user experience, as discussed herein, and/or as known in the art at the time of filing, and/or as developed after the time of filing.

As used herein, the term “user experience” includes not only the user session, interview process, interview process questioning, and/or interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

Herein, the term “party,” “user,” “user consumer,” and “customer” are used interchangeably to denote any party and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “predictive model” is used interchangeably with “analytics model” denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein the term “system access data” denotes data that represents the activities of a user during the user's interactions with a financial system, and represents system access activities and the features and/or characteristics of those activities, according to various embodiments.

As used herein, the term “system access variation data” denotes data that is representative of differences in characteristics and/or features associated with one system access session and another system access session, according to various embodiments.

As used herein, the term “risk categories” denotes characteristics, features, and/or attributes of users or client systems, and represents subcategories of risk that may be used to quantify potentially fraudulent activity, according to various embodiments.

### Hardware Architecture

The present disclosure includes methods and systems for identifying and addressing potential fraudulent (e.g., account takeover) activity in a financial system, according to one embodiment. In one embodiment, a security system identifies and addresses potential account takeover activity in a tax return preparation system. To identify and address the potential fraudulent activity, the security system: receives system access data for a user account, generates one or more risk scores based on the system access data, and performs one or more risk reduction actions based on the likelihood of potential fraud that is represented by the one or more risk scores, according to one embodiment. In other words, when a user accesses a financial system, the financial system creates and stores data that represents the activities of the user during the user's interactions with the financial system. The created and stored data is system access data, according to one embodiment. As disclosed below, the security system uses one or more of system access data, user system characteristics data, and a user's Internet Protocol (“IP”) address, to generate risk scores and to perform risk reduction actions, according to various embodiments.

To detect account take over, the security system analyzes the data that represents the behavior of the user of a client system that is access the financial system. The fraudster may have users' credentials or personally identifiable information (“PII”) that a legitimate user would use to access a user account. Year-to-year changes in browsing behavior can be a strong indicator of potential account takeover activity, according to one embodiment. In fact, in one embodiment, the software system analyzes several factors concurrently, with predictive models, to determine the likelihood of potential account takeover activity in a user account of the financial system.

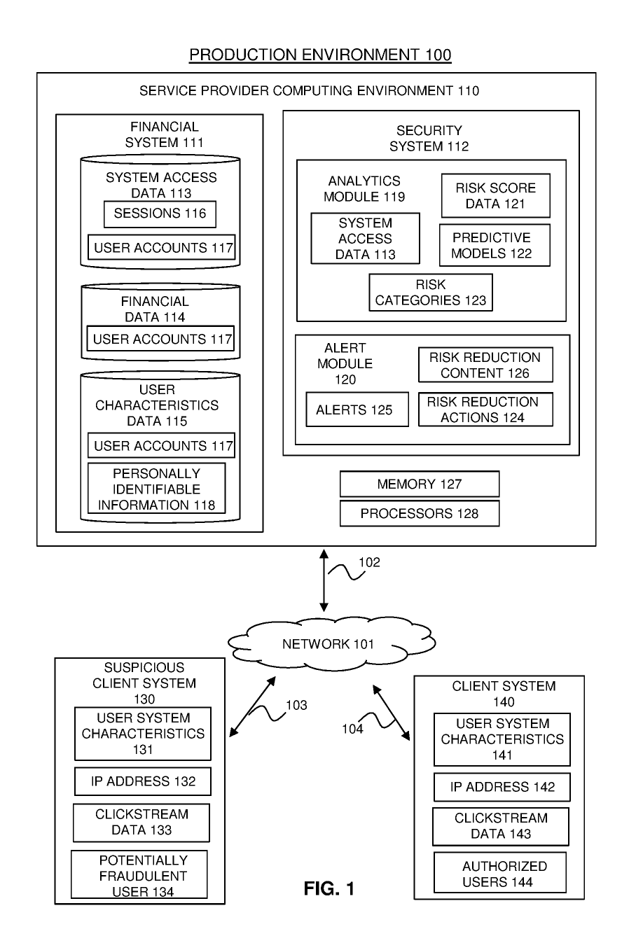

FIG. 1 is an example block diagram of a production environment 100 for identifying and addressing potentially fraudulent (e.g., account takeover) activity in a financial system, in accordance with one embodiment. The production environment 100 illustrates example communications between a suspicious client system, a client system and a service provider computing environment, to describe embodiments of how a security system may identify and address potential account takeover activity. The production environment 100 includes a service provider computing environment 110, a suspicious client system 130, and a client system 140 for identifying and addressing potential fraudulent activity in a financial system, according to one embodiment. The computing environment 110 is communicatively coupled to the suspicious client system 130 and the client system 140 through a network 101 and through communications channels 102, 103, and 104, according to one embodiment.

The service provider computing environment 110 includes a financial system 111 and a security system 112 that is used to identify and address potentially fraudulent activity in the financial system 111, according to one embodiment. The service provider computing environment 110 includes one or more centralized, distributed, and/or cloud-based computing systems that are configured to host the financial system 111 and the security system 112 for a service provider (e.g., Intuit®), according to one embodiment. The financial system 111 establishes one or more user accounts with one or more users of the client system 140 by communicating with the client system 140 through the network 101, according to one embodiment. The suspicious client system 130 also communicates with the financial system 111 to access the one or more user accounts that are associated with authorized users and/or with the client system 140, according to one embodiment. The security system 112 uses information from the financial system 111 to identify the activities of the suspicious system 130 as potentially fraudulent, to determine the likelihood of potentially fraudulent activity from the suspicious client system 130, and to take one or more risk reduction actions to protect the account information in the financial system 111 that is associated with the client system 140, according to one embodiment.

The financial system 111 provides one or more financial services to users of the financial system 111, according to one embodiment. Examples of financial services include, but are not limited to, tax return preparation services, personal financial management services, business financial management services, and the like. The financial system 111 enables users, such as the authorized users 144 of the client system 140, to interact with the financial system 111 based on one or more user accounts that are associated with the authorized users 144, according to one embodiment. The financial system 111 acquires, receives, maintains and/or stores system access data 113, financial data 114, and user characteristics data 115, according to one embodiment.

The financial system 111 creates, stores, and manages the system access data 113, at least partially based on interactions of client systems with the financial system 111, according to one embodiment. The system access data 113 is stored as a table, a database, or some other data structure, according to one embodiment. The system access data 113 can include tens, hundreds, or thousands of features or characteristics associated with an interaction between a client system and the financial system 111, according to one embodiment. The system access data 113 is data that represents system access activities and the features and/or characteristics of those activities, according to one embodiment. The system access activities may occur before, during, and/or after a client system establishes a communications channel/connection with the financial system 111, according to one embodiment. The system access data 113 includes, but is not limited to, data representing: user entered data, event level data, interaction behavior, the web browser of a user's computing system, the operating system of a user's computing system, the media access control (“MAC”) address of the user's computing system, hardware identifiers of the user's computing system, user credentials used for logging in, a user account identifier, the IP address of the user's computing system, a session identifier, interaction behavior during prior sessions, interaction behavior using different computing systems to access the financial system 111, interaction behavior from IP addresses other than a current IP address, IP address characteristics, whether changes are made to user characteristics data, and any other feature/characteristic of system access activity that is currently known at the time of filing or that may be known at a later time for interacting with a financial system, according to one embodiment. In one embodiment, event level data includes data that represents events such as filing a tax return, logging into a user account, entering information into the user account, navigating from one user experience page to another, and the like.

The system access data 113 associates, filters, orders, and/or organizes the features and/or characteristics of system access activities, at least partially based on one or more sessions 116, according to one embodiment. Each of the sessions 116 represent establishing a connection (e.g., a communications channel) between the financial system 111 and a client system with a web browser (e.g., Google Chrome®), according to one embodiment. Thus, a session is initiated if a user accesses one or more user interface displays (e.g., a webpage), and a session is terminated if a user closes some or all of the web browser windows or web browser tabs that are associated with the session that is initiated if the user accesses the one or more user interface displays, according to one embodiment. Each session is associated with session identifier data that represents a session identifier, according to one embodiment. A session and a corresponding session identifier is added to the sessions 116, even if a user does not log into the financial system 111 using valid credentials (e.g., a username and a password), according to one embodiment. As result, the system access data 113 includes system access data/activities for computing systems of authorized users and for computing systems of potentially fraudulent users who access part of the financial system 111 without signing into or logging into a particular account, according to one embodiment.

In one embodiment, the security system 112 uses the system access data 113 that is based on one or more of the sessions 116 to identify and address potentially fraudulent activities, according to one embodiment. For example, the security system 112 analyzes the system access data 113 at least partially based on the number and characteristics of sessions entered into by a particular client system, according to one embodiment. A session-by-session analysis of system access data 113 can be used to show which client systems are access multiple user accounts, in addition to the nature/behavior of the accesses, according to one embodiment.

In one embodiment, the system access data 113 associates, filters, orders, and/or organizes the features and/or characteristics of system access activities, at least partially based on one or more user accounts 117, according to one embodiment. Each of the user accounts 117 represent accounts with one of the authorized users 144, according to one embodiment. Each of the user accounts 117 can be associated with one or more of the sessions 116, depending upon how many times one of the authorized users 144 interacts with the financial system 111 using the credentials associated with one of the user accounts 117, according to one embodiment. Each of the user accounts 117 is associated with one or more user credentials (e.g., a username and a password combination), according to one embodiment. As discussed above, briefly, one of the issues with account takeover fraud is that the cybercriminal/fraudster has usually purchased or otherwise schemed to deceptively obtain the credentials of one or more of the authorized users 144 in order to gain access to one or more of the user accounts 117. As described below, the security system 112 is therefore configured to use characteristics and/or features of the system access activities associated with the system access data 113 to determine a likelihood of potentially fraudulent activity, according to one embodiment. In one embodiment, the security system 112 analyzes system access data 113 on an account-by-account basis to determine similarities in system access activities to label client systems as potentially suspicious and to label navigation behaviors as potentially fraudulent.

The financial system 111 creates, stores, and/or manages the financial data 114 for users of the financial system 111, including the one or more authorized users 144, according to one embodiment. The financial data 114 is stored in a table, database, or other data structure, according to one embodiment. The financial data 114 includes, but is not limited to, data representing: one or more previous years' tax returns, and incomplete tax return, salary information, tax deduction information, tax liability history, personal budget information, partial or whole bank account information, personal expenditures, accounts receivable, accounts payable, annual profits for business, financial institution money transfer history, checking accounts, savings accounts, lines of credit, and the like, according to one embodiment. The financial system 111 receives and/or obtains the financial data 114 directly from one or more of the authorized users 144, according to one embodiment. The financial system 111 receives and/or obtains the financial data 114 for one or more of the authorized users 144 after or while setting up one or more user accounts 117 for one or more of the authorized users 144, according to one embodiment. The financial data 114 is organized/keyed off of one or more of the user accounts 117, according to one embodiment.

The financial system 111 creates, stores, and/or manages the user characteristics data 115 that is associated with users of the financial system 111, including the one or more authorized users 144, according to one embodiment. The user characteristics data 115 is stored in a table, database, or some other data structure, according to one embodiment. The user characteristics data 115 is sorted, filtered, and/or organized based on one or more of the user accounts 117, in the data structure, according to one embodiment. The user characteristics data 115 includes personally identifiable information 118 (“PII”) for each of the authorized users 144, according to one embodiment. Personally identifiable information includes, but is not limited to, a Social Security number, employer identification number, driver's license number, hospital number, home address, combinations of other user characteristics data 115, or any other information that can be used to distinguish one user (e.g., person or organization) from another, according to one embodiment. In addition to personally identifiable information 118, the user characteristics data 115 includes, but is not limited to, data representing: browsing/navigation behavior within the financial system 111, type of web browser, type of operating system, manufacturer of computing system, whether the user's computing system is a mobile device or not, a user's name, a Social Security number, government identification, a driver's license number, a date of birth, an address, a zip code, a home ownership status, a marital status, an annual income, a job title, an employer's address, spousal information, children's information, asset information, medical history, occupation, information regarding dependents, salary and wages, interest income, dividend income, business income, farm income, capital gain income, pension income, individual retirement account (“IRA”) distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial system or in providing one or more financial services, according to various embodiments. According to one embodiment, the security system 112 uses the user characteristics data 115 and/or the financial data 114 and/or the system access data 113 to determine a likelihood of potentially fraudulent activity by one or more client systems, such as the suspicious client system 130, according to one embodiment.

The client system 140 is used to communicate with and/or interact with the financial system 111, according to one embodiment. The client system 140 is representative of one of hundreds, thousands, or millions of client systems used by users to access the financial system 111, according to one embodiment. The client system 140 includes user system characteristics 141, an Internet Protocol (“IP”) address 142, clickstream data 143, and authorized users 144, according to one embodiment. In one embodiment, only one authorized user uses the client system 140 to access the financial system. In one embodiment, the client system 140 is a family computer or a public computer that is used by multiple authorized users to access the financial system 111.

The user system characteristics 141 include one or more of an operating system, a hardware configuration, a web browser, information stored in one or more cookies, the geographical history of use of the client system 140, the IP address 142, and other forensically determined characteristics/attributes of the client system 140, according to one embodiment. The user system characteristics 141 are represented by a user system characteristics identifier that corresponds with a particular set of user system characteristics during one or more of the sessions 116 with the financial system 111, according to one embodiment. Because the client system 140 may use different browsers or different operating systems at different times to access the financial system 111, the user system characteristics 141 for the client system 140 may be assigned several user system characteristics identifiers, according to one embodiment. The user system characteristics identifiers are called the visitor identifiers (“VIDs”), according to one embodiment.

The IP address 142 can be static, can be dynamic, and/or can change based on the location (e.g., a coffee shop) for which the client system 140 accesses the financial system 111, according to one embodiment. The financial system 111 and/or the security system 112 may use an IP address identifier to represent the IP address and/or additional characteristics of the IP address 142, according to one embodiment.

The clickstream data 143 represents the browsing/navigation behavior of one or more of the authorized users 144 while interacting with the financial system 111, according to one embodiment. The clickstream data 143 is captured and/or stored in the system access data 113 and/or the user characteristics data 115, according to one embodiment.

When a new one of the user accounts 117 is created, the financial system 111 stores one or more of the user system characteristics 141, the IP address 142, and the clickstream data 143, and associates these features of the client system 140 with one or more of the authorized users 144 and with one or more of the user accounts 117 that correspond with the authorized users 144, according to one embodiment. The security system 112 detects and uses variations in the characteristics of the client system 140 and changes in the behavior of the authorized users 144 to detect and identify potentially fraudulent activity that corresponds with account takeover activity for one or more user accounts 117 and for one or more of the authorized users 144, according to one embodiment.

The suspicious client system 130 is similar to the client system 140, in that the suspicious client system 130 includes user system characteristics 131, an IP address 132, and clickstream data 133, according to one embodiment. The suspicious client system 130 includes a potentially fraudulent user 134, according to one embodiment. The suspicious client system 130 is representative of just one of potentially multiple client systems that may be used by unauthorized users to access other people's accounts in the financial system 111, according to one embodiment. Of course, although one potentially fraudulent user 134 is specifically called out, multiple potentially fraudulent users can be sharing the suspicious client system 130 to conduct potentially fraudulent or to conduct fraudulent activity with the financial system 111, according to one embodiment. The user system characteristics 131 are associated with a user system characteristics identifier, which can be generated based on a combination of the hardware and software used by the suspicious client system 130 to access the financial system 111 during one or more sessions 116, according to one embodiment. The user system characteristics 131 are associated with a user system characteristics identifier, which can be generated based on a combination of the hardware and software used by the suspicious client system 130 to access one or more of the user accounts 117, according to one embodiment. As discussed above, the system access data 113 and/or the user characteristics data 115 include the user system characteristics 131, the IP address 132, and the clickstream data 133 for the potentially fraudulent user 134 and/or for the suspicious client system 130, according to one embodiment. As described, the security system 112 uses one or more of the system access data 113, the financial data 114, and the user characteristics data 115, to determine the likelihood that the suspicious client system 130 and/or the potentially fraudulent user 134 is participating in potentially fraudulent activities during his or her use of the financial system 111, according to one embodiment.

To determine the likelihood that a suspicious client system 130 (or any other client system) is performing potential account takeover activities, the security system 112 uses an analytics module 119 and an alert module 120, according to one embodiment. Although embodiments of the functionality of security system 112 will be described in terms of the analytics module 119 and the alert module 120, the security system 112, the financial system 111, and/or service provider computing environment 110 may use one or more alternative terms and/or techniques for organizing the operations, features, and/or functionality of the security system 112 that is described herein. In one embodiment, the security system 112 (or the functionality of the security system 112) is partially or wholly integrated/incorporated into the financial system 111.

The security system 112 generates risk score data 121 for system access activities that are represented by the system access data 113, to determine a likelihood of potential account takeover activity in the financial system 111, according to one embodiment. The analytics module 119 and/or the security system 112 acquire the system access data 113 from the financial system 111 and/or from a centralized location where the system access data 113 is stored for use by the financial system 111, according to one embodiment. The analytics module 119 and/or the security system 112 applies the system access data 113 to one or more predictive models 122, to generate the risk score data 121 that represents one or more risk scores, according to one embodiment. The analytics module 119 and/or the security system 112 defines the likelihood of potential account takeover at least partially based on the risk scores (represented by the risk score data 121) that are output from the one or more predictive models 122, according to one embodiment.

The analytics module 119 and/or the security system 112 uses one or more of the predictive models 122 to generate risk score data 121 for one or more risk categories 123, according to one embodiment. The risk categories 123 represent characteristics, features, and/or attributes of the authorized users 144 of the client system 140, of the suspicious client system 130, and/or of the potentially fraudulent user 134, according to one embodiment. The risk categories 123 have risk category identifiers that include, but are not limited to, a user system characteristics identifier (a.k.a., visitor ID or “VID”), an IP address identifier, and a user account identifier (a.k.a., auth ID), according to one embodiment. In other words, each of the predictive models 122 receives the system access data 113 (or other input data) and generates one risk score (represented by the risk score data 121) for each of the risk categories 123, according to one embodiment. To illustrate with an example, the analytics module 119 receives system access data 113 (representative of tens, hundreds, or thousands of characteristics or features of system access activities for a session), the analytics module 119 applies the system access data 113 to one of the predictive models 122, the predictive model generates a risk score of .72 (represented by the risk score data 121) for the IP address 132 of the suspicious client system 130, and the analytics module 119 and/or the security system 112 determines whether a risk score of .72 is a strong enough indication of a security threat to warrant performing one or more risk reduction actions.

The security system 112 creates the user system characteristics identifier, as one example of a risk category identifier, to track the system access activities associated with a particular computing system configuration, according to one embodiment. If for example, one of the authorized users 144 has an account with the financial system 111 and accesses the financial system 111 with the same user system characteristics identifier consistently, then the security systems 112 may be configured to raise the risk score associated with the user system characteristics identifier if a user (e.g., a potentially fraudulent user 134) uses a completely different user systems characteristic identifier to access the account, according to one embodiment. The risk score associated with the user system characteristics identifier is increased even further, if other browsing behaviors (e.g., uncharacteristically accesses the financial system 111 in the middle of the night) also change at the same time that a new/unknown user system characteristics identifier accesses and/or modifies an account for the authorized user, according to one embodiment. The security system 112 is particularly sensitive to year to year changes for the user accounts 117 of the authorized users 144, according to one embodiment. In other words, although the security system 112 is configured to determine likelihoods of potentially fraudulent activity by using multifactor analysis, some characteristics (e.g., year to year changes) may be more dominant indicators of potential account takeover activity for an account, according to one embodiment.

The security system 112 creates the IP address identifier, as one example of a risk category identifier, to track the system access activities associated with a particular IP address, according to one embodiment. The IP address identifier may be data that simply represents the IP address of the computing system that accesses the financial system 111, according to one embodiment. The IP address identifier is derived from or at least partially based on the IP address, according to one embodiment. The security system 112 uses the IP address identifier as a characteristic of system access activity for user, according to one embodiment. If, for example, a user consistently uses a single IP address to login to the financial system 111, then a change in that behavior causes the security system 112 to increase the risk score for the IP address indicator for an account that is being accessed from the IP address, according to one embodiment. If, for example, a user consistently uses IP addresses from the West Coast of the United States to login to the financial system 111, then logins from South America, Asia, or Europe causes the security system 112 to increase the risk score for the IP address indicator for an account that is being accessed from the IP address, according to one embodiment. If for example, a user consistently uses a fixed IP addresses associated with a corporation to login to the financial system 111, then logins from dynamically allocated IP addresses, (such as those that may be allocated from Amazon Web Services) may cause the security system 112 to increase the risk score for the IP address indicator for the user account that is being accessed from the dynamically allocated IP address, according to one embodiment. Other characteristics of the IP address indicator or of the IP address, such as whether the IP address is associated with a residence or a corporation instead of a coffee shop or a library, can be used to assess the level of risk assigned to the IP address that is being used to access a user account in the financial system 111, according to one embodiment. Because the security system 112 monitors IP addresses that are used to initiate the sessions 116 with the financial system 111, the financial system 111 and the security system 112 may have system access data 113 for an IP address and other information about a suspicious client system before the IP address is even used to log into an account, according to one embodiment. The session-based information can also be used by the security system 112 to determine a level of risk is associated with or assigned to an IP address indicator, according to one embodiment.

The security system 112 creates the user account identifier (e.g., an “auth ID”), as one example of a risk category identifier, to track the system activities associated with a particular user account, according to one embodiment. The account identifier can include a username, a password, a combination of username and password, a cryptographic hash function applied to a username and/or a password, or some other data that is at least partially based on credentials of an authorized user who has an account, according to one embodiment. The security system 112 uses the user account identifier and/or the IP address identifier and/or the user system characteristics identifier to track and compare prior year's activities with current activities, according to one embodiment. The security system 112 tracks and compares activities such as user entered data, event level data, interaction behavior, and the like, according to one embodiment. The combination of receiving, storing, monitoring, and comparing system access activities (represented by system access data 113 and/or user characteristics data 115) enables the security system 112 to detect and identify irregularities in user behavior and assign likelihoods of risk associated with the system of access activities, according to one embodiment.

Each of the predictive models 122 can be trained to generate the risk score data 121 based on one or more of the system access data 113, the financial data 114, and the user characteristics data 115, according to one embodiment. Each of the one or more predictive models 122 are trained generate a risk score or risk score data 121 for one particular risk category (e.g., user system characteristics identifier, IP address identifier, user account identifier, etc.), according to one embodiment. The risk score data 121 represents a risk score that is a number (e.g., a floating-point number) ranging from 0-1 (or some other range of numbers), according to one embodiment. The closer the risk score is to 0, the lower the likelihood is that potentially fraudulent activity has occurred for a particular risk category. The closer the risk score is to 1, the higher the likelihood is that potentially fraudulent activity has occurred for a particular risk category. Returning to the example of a risk score of 0.72 for the IP address 132 (e.g., the IP address identifier), it would be more likely than not that the IP address 132 has been used to perform actions that one or more of the predictive models 122 has been trained to identify as potentially fraudulent, according to one embodiment.

Each of the predictive models 122 is trained using information from the financial system 111 that has been identified or reported as being linked to some type of fraudulent activity, according to one embodiment. Customer service personnel or other representatives of the service provider receive complaints from a user when the user accounts for the financial system 111 do not work as expected or anticipated (e.g., a tax return has been filed from a user's account without their knowledge). When customer service personnel look into the complaints, they may occasionally identify actions that have been taken with users' accounts that contradict information provided by the users while communicating with the customer service personnel (e.g., a tax return has been filed from a user's account without their knowledge). When it appears that a legitimate username, password, or other credentials have been provided to the financial system 111 to access, change, or otherwise manipulate one or more of the user accounts 117, without authorization of one of the authorized users 144, the activities or the session associated with the manipulation of the user's account is identified or flagged for potential or actual account takeover activity, according to one embodiment. One or more predictive model building techniques is applied to the system access data, financial data, and/or user characteristics data to generate one or more of the predictive models 122 for one or more of the risk categories 123, according to one embodiment. The one or more predictive models 122 are trained using one or more of a variety of machine learning techniques including, but not limited to, regression, logistic regression, decision trees, artificial neural networks, support vector machines, linear regression, nearest neighbor methods, distance based methods, naive Bayes, linear discriminant analysis, k-nearest neighbor algorithm, or another mathematical, statistical, logical, or relational algorithm to determine correlations or other relationships between the likelihood of potential account takeover activity and the system access data 113, the financial data 114, and/or the user characteristics data 115, according to one embodiment.

The analytics module 119 and/or the security system 112 can use the risk scores represented by the risk score data 121 in a variety of ways, according to one embodiment. In one embodiment, a determination to take corrective action or to take risk reduction actions is based on a risk score for one of the risk categories 123 (e.g., IP address). In one embodiment, a determination to take corrective action or to take risk reduction action is based on a combination of risk scores for 2 or more of the risk categories 123 (e.g., IP address and user system characteristics).

In one embodiment, the predictive models 122 are applied to existing sessions 116 that represent a low likelihood for fraudulent activity as well as to existing sessions 116 that represent a high likelihood for fraudulent activity, to define risk score thresholds to apply to the risk score data 121, according to one embodiment. In one embodiment, the risk score data 121 is compared to one or more predefined risk score thresholds to determine if one or more of the risk categories 123 has a high enough likelihood of potential fraudulent characteristics to warrant performing risk reduction actions. Examples of risk score thresholds include 0.8 for user system characteristics, 0.95 for an IP address, and 0.65 for a user account, according to one example of an embodiment. These values are merely illustrative and are determined based on applying the predictive models 122 to existing system access data 113 and/or are determined based on user satisfaction/complaints about the received financial services, according to one embodiment.

By defining and applying risk score thresholds to the risk score data 121, the security system 112 can control the number of false-positive and false-negative determinations of potentially fraudulent activity between client systems and the financial system 111, according to one embodiment. When a suspicious client system is identified as having a high likelihood of association with potentially fraudulent activity, the security system 112 executes one or more risk reduction actions to protect the account of the authorized user, according to one embodiment. However, if the security system 112 flags system access activity as potentially fraudulent when the system access activity is not fraudulent, then the flagged activity is a false-positive and the authorized user is inconvenienced with proving his or her identity and/or with being blocked from accessing the financial system 111, according to one embodiment. Thus, tuning the financial system 111 and/or the risk score thresholds to control the number of false-positive determinations will improve users' experience with the financial system 111, according to one embodiment.

A less-desirable scenario than flagging a session as false-positive might be flagging a session as false-negative for potentially fraudulent activity between client systems in the financial system 111, according to one embodiment. If the security system 112 flags system access activity as not being potentially fraudulent when in fact the system activity has a high likelihood of potentially fraudulent, then the non-flagged activity is a false-negative, and the authorized user of the account that is vandalized may lose access to his or her account and may (at least temporarily) have financial losses associated with theft, according to one embodiment. Thus, tuning the financial system and/or the risk score thresholds to control the number of false-negative determinations will improve users' experience with the financial system 111, according to one embodiment.

The security system 112 uses the alert module 120 to execute one or more risk reduction actions 124, upon determining that all or part of the risk score data 121 indicates a likelihood of potentially fraudulent activity occurring in the financial system 111 for at least one of the user accounts 117, according to one embodiment. The alert module 120 is configured to coordinate, initiate, or perform one or more risk reduction actions 124 in response to detecting and/or generating one or more alerts 125, according to one embodiment. The alert module 120 and/or the security system 112 is configured to compare the risk score data 121 to one or more risk score thresholds to quantify the level of risk associated with one or more system access activities and/or associated with one or more client systems, according to one embodiment. The alerts 125 include one or more flags or other indicators that are triggered, in response to at least part of the risk score data 121 exceeding one or more risk score thresholds, according to one embodiment. The alerts 125 include an alert for each one of the risk categories 123 that exceeds a predetermined and/or dynamic risk score threshold, according to one embodiment. The alerts 125 include a single alert that is based on a sum, an average, or some other holistic consideration of the risk scores associated with the risk categories 123, according to one embodiment.

If at least part of the risk score data 121 indicates that potentially fraudulent activity is occurring or has occurred for one of the user accounts 117, the alert module uses risk reduction content 126 and performs one or more risk reduction actions 124 to protect one or more of the authorized users 144, according to one embodiment. The risk reduction content 126 includes, but is not limited to, banners, messages, audio clips, video clips, avatars, other types of multimedia, and/or other types of information that can be used to notify a system administrator, customer support, an authorized user associated with an account that is under inspection, a government entity, a state or federal revenue service, and/or a potentially fraudulent user 134, according to one embodiment. The risk reduction actions 124 include, but are not limited to, challenging the authentication of the user, removing multi-factor authentication options (e.g., removing email as a multi-factor authentication option), increasing the difficulty of multi-factor authentication options, sending a text message to an authorized user, logging a user out of a session with the financial system 111, ending a session, blocking access to the financial system 111, suspending credentials (at least temporarily) of an authorized user, preventing a user from making one or more changes to one or more user accounts 117, preventing (at least temporarily) a user from executing one or more operations within the financial system 111 (e.g., preventing the user from filing a tax return or from altering which financial institution account is set up to receive a tax refund), and the like, according to various embodiments.

In one embodiment, the security system 112 analyzes system access data 113 in a batch mode. For example, the security system 112 periodically (e.g., at the end of each day) fetches or receives one or more of the system access data 113, the financial data 114, and the user characteristics data 115 to perform account takeover analysis, according to one embodiment.

In one embodiment, the security system 112 provides real-time account takeover identification and remediation services. Each time a user account is accessed, the financial system 111 executes and/or calls the services of the security system 112 to generate risk score data 121 for the client system that accesses the account, according to one embodiment. In one embodiment, the security system 112 continuously or periodically (e.g., every 1, 5, 10, 15 minutes, etc.) applies system access data to the one or more predictive models 122 to generate risk score data 121 for users as they access or attempt to access the financial system 111.

The service provider computing environment 110 and/or the financial system 111 and/or the security system 112 includes memory 127 and processors 128 to support operations of the financial system 111 and/or of the security system 112 in identifying and addressing potential account takeover activities in the financial system 111, according to one embodiment. In one embodiment, the security system 112 includes instructions that are represented as data that are stored in the memory 127 and that are executed by one or more of the processors 128 to perform a method of identifying and addressing potential account takeover (i.e., fraudulent) activities in the financial system 111.

By receiving various information from the financial system 111, analyzing the received information, quantifying a likelihood of risk based on the information, and performing one or more risk reduction actions 124, the security system 112 works with the financial system 111 to improve the security of the financial system 111, according to one embodiment. In addition to improving the security of the financial system 111, the security system 112 protects financial interests of customers of the service provider, to maintain and/or improve consumer confidence in the security and functionality of the financial system 111, according to one embodiment. Furthermore, the security system 112 addresses the long-standing an Internet-centric problem of cyber criminals stealing and using the credentials of authorized users to perform unauthorized actions (e.g., stealing electronically transferable funds from authorized users of financial systems), according to one embodiment.

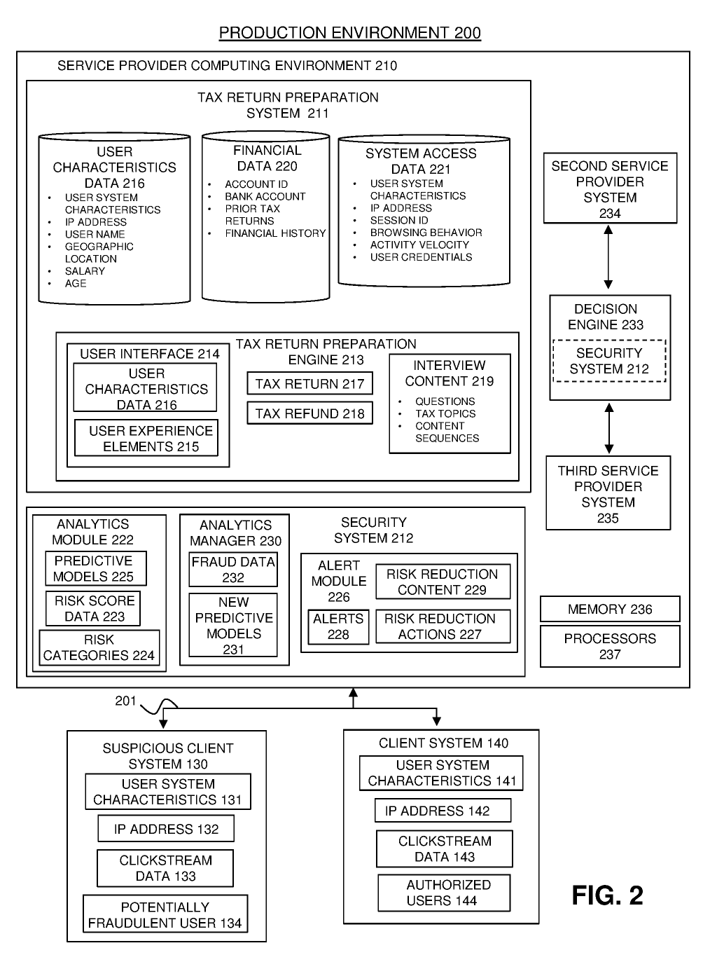

FIG. 2 illustrates a production environment 200 for identifying and addressing potential account takeover activities in a tax return preparation system, as a particular example of a financial system, according to one embodiment. The production environment 200 includes a service provider computing environment 210, the suspicious client system 130 (of FIG. 1), and the client system 140 (of FIG. 1), according to one embodiment. The service provider computing environment 210 is communicatively coupled to one or more of the suspicious client system 130, and the client system 140 through one or more communications channels 201 (e.g., the Internet), according to one embodiment. The service provider computing environment 210 includes a tax return preparation system 211 and a security system 212 for identifying and addressing potential account takeover activities in the tax return preparation system 211, according to one embodiment.

The tax return preparation system 211 progresses users through a tax return preparation interview to acquire user characteristics data, to prepare tax returns for users, and/or to assist users in obtaining tax credits and/or tax refunds, according to one embodiment. The tax return preparation system 211 is one embodiment of the financial system 111 (shown in FIG. 1).

The tax return preparation system 211 uses a tax return preparation engine 213 to facilitate preparing tax returns for users, according to one embodiment. The tax return preparation engine 213 provides a user interface 214, by which the tax return preparation engine 213 delivers user experience elements 215 to users to facilitate receiving user characteristics data 216 from users, according to one embodiment. The tax return preparation engine 213 uses the user characteristics data 216 to prepare a tax return 217, and to (when applicable) assist users in obtaining a tax refund 218 from state and federal revenue services, according to one embodiment. The tax return preparation engine 213 populates the user interface 214 with user experience elements 215 that are selected from interview content 219, according to one embodiment. The interview content 219 includes questions, tax topics, content sequences, and the like for progressing users through a tax return preparation interview, to facilitate the preparation of a tax return 217 for each user, according to one embodiment.

The tax return preparation system 211 stores the user characteristics data 216 in a database, for use by the tax return preparation system 211 and/or for use by the security system 212, according to one embodiment. The user characteristics data 216 is an implementation of the user characteristics data 115 (shown in FIG. 1), which is described above, according to one embodiment. The user characteristics data 216 is a table, database, or other data structure, according to one embodiment.

The tax return preparation system 211 receives and stores financial data 220 in a table, database, or other data structure, for use by the tax return preparation system 211 and/or for use by the security system 212, according to one embodiment. The financial data 220 includes the financial data 114 (shown in FIG. 1), according to one embodiment. The financial data 220 includes, but is not limited to, account identifiers, bank accounts, prior tax returns, and the financial history of users of the tax return preparation system 211, according to one embodiment.

The tax return preparation system 211 acquires and stores the system access data 221 in a table, database, or other data structure, for use by the tax return preparation system 211 and/or for use by the security system 212, according to one embodiment. The system access data 221 includes the system access data 113 (shown in FIG. 1), according to one embodiment. The system access data 221 includes, but is not limited to, data representing one or more of: user system characteristics, IP addresses, session identifiers, browsing behavior, and user credentials, according to one embodiment.

The service provider computing environment 210 uses the security system 212 to identify and address potential account takeover activity in the tax return preparation system 211, according to one embodiment. The security system 212 is an implementation of the security system 112 (shown in FIG. 1), according to one embodiment. The security system 212 requests and/or acquires information from the tax return preparation system 211 and determines the likelihood of potential account takeover activity for the interactions of one or more client systems with the tax return preparation system 211, according to one embodiment. The security system 212 is part of the same service provider computing environment as the tax return preparation system 211, and therefore obtains access to the user characteristics data 216, the financial data 220, and system access data 221, by generating one or more data requests (e.g., database queries) in the service provider computing environment 210, according to one embodiment.

The security system 212 uses an analytics module 222 to analyze one or more of the system access data 221, the financial data 220, and the user characteristics data 216 to determine risk score data 223 for the interactions of client systems with the tax return preparation system 211, according to one embodiment. The risk score data 223 represents risk scores that are a likelihood of potential account takeover or fraud activity for one or more risk categories 224 that are associated with a user account in the tax return preparation system 211, according to one embodiment. The analytics module 222 transforms one or more of the system access data 221, the financial data 220, and the user characteristics data 216 into the risk score data 223, according to one embodiment. The analytics module 222 applies one or more of the system access data 221, the financial data 220, and the user characteristics data 216 to one or more predictive models 225 in order to generate the risk score data 223, according to one embodiment. In one embodiment, the one or more predictive models 225 transform input data into risk score data 223 that represents one or more risk scores for one or more risk categories 224 for one or more user accounts in the tax return preparation system 211. Each of the predictive models 225 generates risk score data 223 that is associated with a single one of the risk categories 224 (e.g., user system characteristics, IP address, user account, etc.), according to one embodiment. The analytics module 222 is one implementation of the analytics module 119, according to one embodiment. The analytics module 222 includes some or all of the features of the analytics module 119, according to one embodiment.

The security system 212 uses an alert module 226 to perform one or more risk reduction actions 227, in response to determining that potential account takeover activity is occurring or has occurred in the tax return preparation system 211 for one or more user accounts, according to one embodiment. The alert module 226 receives alerts 228, risk score data 223, or other notifications that potential account takeover activity has occurred, according to one embodiment. The alert module 226 uses risk reduction content 229 (e.g., messages, multimedia, telecommunications messages, etc.) while performing one or more of the risk reduction actions 227, according to one embodiment. The alert module 226 is one implementation of the alert module 120 (shown in FIG. 1), according to one embodiment. The alert module 226 includes one or more of the features/functionality of the alert module 120 (shown in FIG. 1), according to one embodiment.

The security system 212 uses an analytics manager 230 to train new predictive models 231 based on fraud data 232, according to one embodiment. The new predictive models 231 are used to replace the predictive models 225 as the analytics manager 230 trains/updates predictive models for use in the security system 212, according to one embodiment. The fraud data 232 is data that is verified as being associated with fraudulent activity (e.g., account takeover activity) in the tax return preparation system 211, according to one embodiment.

The service provider computing environment 210 includes a decision engine 233 that is used to host services to various applications and systems within the service provider computing environment 210, according to one embodiment. The service provider computing environment 210 uses the decision engine 233 to host the security system 212 to provide security services to a second service provider system 234 and to a third service provider system 235, according to one embodiment. The second service provider system 234 is a personal finance management system (e.g., Mint®), and the third service provider system 235 is a business finance management system (e.g., QuickBooks Online®), according to one embodiment.

The service provider computing environment 210 includes memory 236 and processors 237 for providing methods and systems for identifying and addressing potential account takeover activities/fraud in the tax return preparation system 211, according to one embodiment. The memory 236 stores data representing computer instructions for the tax return preparation system 211 and/or the security system 212, according to one embodiment.

### Process

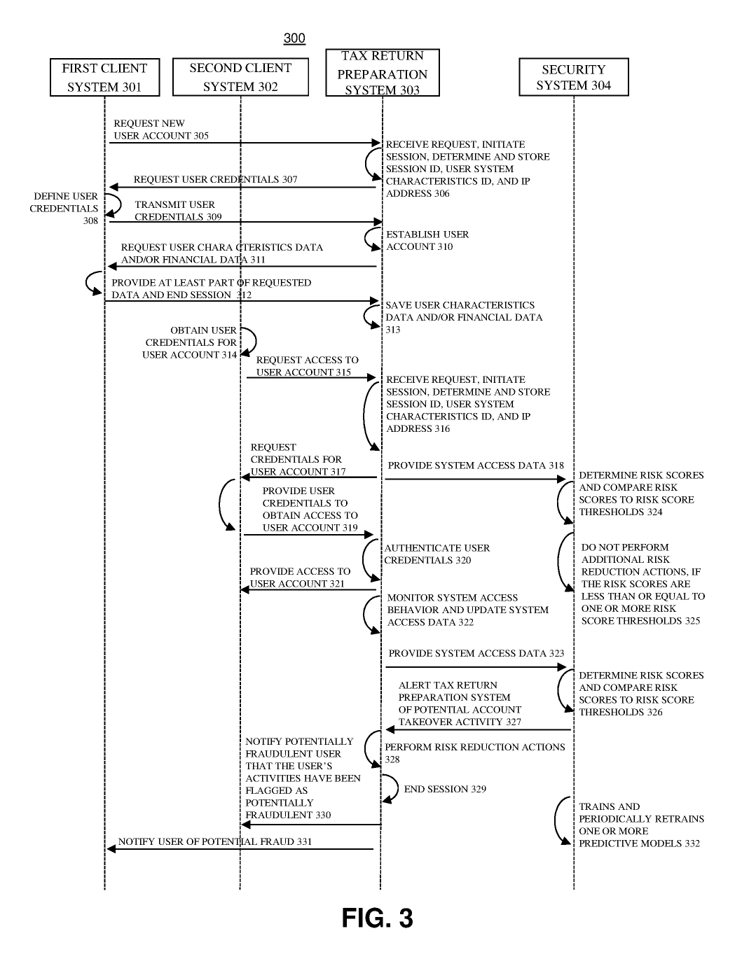

FIG. 3 illustrates an example flow diagram of a process 300 for identifying and addressing potential account takeover in a tax return preparation system, according to one embodiment. The process 300 includes operations for a first client system 301, a second client system 302, a tax return preparation system 303, and a security system 304, according to one embodiment. The first client system 301 is the client system 140 (shown in FIG. 1), according to one embodiment. The second client system 302 is the suspicious client system 130 (shown in FIG. 1), according to one embodiment. The tax return preparation system 303 is the financial system 111 (shown in FIG. 1) or the tax return preparation system 211 (shown in FIG. 2), according to one embodiment. The security system 304 is the security system 112 (shown in FIG. 1) or the security system 212 (shown in FIG. 2), according to one embodiment.

At operation 305, the first client system 301 requests a new user account for the tax return preparation system 303, according to one embodiment. The first client system 301 requests the new user account by, for example, accessing a universal resource locator (“URL”) for the tax return preparation system 303, according to one embodiment. The first client system 301 requests a new user account by, for example, clicking on a button that is labeled “new account,” “the user,” or the like, according to one embodiment. Operation 305 proceeds to operation 306, according to one embodiment.

At operation 306, the tax return preparation system 303 receives the request, initiates a session, determines and stores a session ID, a user system characteristics ID, and an IP address, according to one embodiment. In one embodiment, a session ID is a session identifier that is used to identify the session that is initiated when the first client system 301 requests the new user account, according to one embodiment. The user system characteristics ID is a user system characteristics identifier that is one example of a risk category, according to one embodiment. The user system characteristics ID is determined based on one or more of the operating system, the browser, the type of computing device, the IP address, and other characteristics of the first client system 301, according to one embodiment. Operation 306 proceeds to operation 307, according to one embodiment.

At operation 307, the tax return preparation system 303 requests user credentials from the first client system 301, according to one embodiment. Operation 307 proceeds to operation 308, according to one embodiment.

At operation 308, the first client system 301 defines the user credentials, according to one embodiment. In one embodiment, the first client system 301 defines the user credentials based on a username and/or a password that are selected by a user of the first client system 301, according to one embodiment. Operation 308 proceeds to operation 309, according to one embodiment.

At operation 309, the first client system 301 transmits the user credentials to the tax return preparation system 303, according to one embodiment. The first client system 301 transmits the user credentials to the tax return preparation system 303, for example, in response to a user selecting a “submit” button, according to one embodiment. Operation 309 proceeds to operation 310, according to one embodiment.

At operation 310, the tax return preparation system 303 establishes a user account, according to one embodiment. The user account is associated with a user account identifier, which is based on the user credentials and/or another account identifier created by the tax return preparation system 303 for the new user, according to one embodiment. Operation 310 proceeds to operation 311, according to one embodiment.

At operation 311, the tax return preparation system 303 requests user characteristics data and/or financial data from the first client system 301, according to one embodiment. The tax return preparation system 303 requests user characteristics data and/or financial data from the user of the first client system 301 by progressing a user through a tax return preparation interview, to facilitate preparing and filing a user's tax return, according to one embodiment. Operation 311 proceeds to operation 312, according to one embodiment.

At operation 312, the first client system 301 provides at least part of the requested data to the tax return preparation system 303 and ends the session, according to one embodiment. The first client system 301 and the session when a user closes a browser, turns off the first client system 301, or the like, to disconnect any communications channels established with the tax return preparation system 303, according to one embodiment. Operation 312 proceeds to operation 313, according to one embodiment.

At operation 313, the tax return preparation system 303 saves the user characteristics data and/or the financial data, according to one embodiment.

At operation 314, a second client system 302 obtains user credentials for the user account, according to one embodiment. The second client system 302 may be operated by a processor/cybercriminal and may obtain user credentials and/or PII for user by using phishing or malware attacks and/or through one or more underground sales platforms. Operation 314 proceeds to operation 315, according to one embodiment.

At operation 315, the second client system 302 requests access to the user account from the tax return preparation system 303, according to one embodiment. Operation 315 proceeds to operation 316, according to one embodiment.

At operation 316, the tax return preparation system 303 receives the request, initiates a session, determines and stores session ID, a user system characteristics identifier, and an IP address, according to one embodiment. Operation 316 proceeds to operation 317 and operation 318, according to one embodiment. Operation 316 proceeds to operation 317 prior to operation 318, according to one embodiment. Operation 316 proceeds to operation 318 prior to operation 317, according to one embodiment.

At operation 317, the tax return preparation system 303 requests credentials for the user account from the second client system 302, according to one embodiment. Operation 317 proceeds to operation 319, according to one embodiment.

At operation 319, the second client system 302 provides user credentials to the tax return preparation system 303 to obtain access to the user account, according to one embodiment. Operation 319 proceeds to operation 320, according to one embodiment.

At operation 320, the tax return preparation system 303 authenticates the user credentials, according to one embodiment. Operation 320 proceeds to operation 321, according to one embodiment.

At operation 321, the tax return preparation system 303 provides access to the user account to the second client system 302, according to one embodiment. Operation 321 proceeds to operation 322, according to one embodiment.

At operation 322, the tax return preparation system 303 monitors system access behavior and updates system access data, according to one embodiment. The system access data is data that represents system access activities in the tax return preparation system 303 by client devices, in addition to features and/or characteristics of the client devices and of the system access activities, according to one embodiment. Operation 322 proceeds to operation 323, according to one embodiment.

Returning to operation 318, at operation 318, the tax return preparation system 303 provides system access data to the security system 304, according to one embodiment. Operation 318 proceeds to operation 324, according to one embodiment.

At operation 324, the security system 304 determines risk scores and compares risk scores to risk score thresholds, according to one embodiment. Operation 324 proceeds to operation 325, according to one embodiment.

At operation 325, the security system 304 does not perform additional risk reduction actions, if the risk scores are less than or equal to one or more risk score thresholds, according to one embodiment. The security system 304 performs the operations 324 and 325 repeatedly and/or concurrently with the second client system 302 performing one or more of operations 317, 319, and/or 321, according to one embodiment.

Returning to operation 323, at operation 323, the tax return preparation system 303 provides system access data to the security system 304, according to one embodiment. The new system access data or the updated system access data includes browsing behavior, navigation behavior, and/or account modifications that is performed by the second client system 302 upon receipt of access to the user account, according to one embodiment. Operation 323 proceeds to operation 326, according to one embodiment.

At operation 326, the security system 304 determines risk scores and compares the risk scores to risk score thresholds, according to one embodiment. If one or more of the risk scores (represented by risk score data) exceeds one or more of the corresponding risk or thresholds, the security system takes one or more measures towards reducing the liability and/or cyber exposure of the content of the user account, to protect the authorized user of the user account, according to one embodiment. Operation 326 proceeds to operation 327, according to one embodiment.

At operation 327, the security system 304 alerts the tax return preparation system 303 of potential account takeover activity, according to one embodiment. Operation 327 proceeds to operation 328, according to one embodiment.

At operation 328 the tax return preparation system 303 performs risk reduction actions, according to one embodiment. In one embodiment, the security system 304 performs one or more risk reduction actions. Operation 328 proceeds to operation 329, 330, and/or 331, according to one embodiment. Operation 329, 330, and 331 are performed in any one of a number of sequences (e.g., operation 330 being first, operation 331 being second, and operation 329 being last, etc.), according to one embodiment.

At operation 329, the tax return preparation system 303 ends the current session, according to one embodiment. By ending the current session with the second client system 302, the tax return preparation system 303 prevents the second client system 302 from further manipulating the user account, according to one embodiment. In other words, by ending the current session, the tax return preparation system 303 prevents the second client system 302 from performing additional activities within the user account to reduce the likelihood of privacy and/or financial losses, according to one embodiment.

At operation 330, the tax return preparation system 303 notifies the potentially fraudulent user that the user's activities have been flagged as potentially fraudulent, according to one embodiment. The tax return preparation system 303 notifies a potentially fraudulent user by displaying a message within a user interface that the current session may be or is being terminated, according to one embodiment. The tax return preparation system 303 is configured to display an on-screen message that notifies the potentially fraudulent user that a telecommunications message will be provided to the authorized user of the user account through one or more of an email, a text message, or a telephone call, according to one embodiment.

At operation 331, the tax return preparation system 303 emails, text messages, or calls the authorized user to notify the authorized user of potentially fraudulent activity, according to one embodiment.

At operation 332, the security system 304 trains and periodically re-trains one or more predictive models, according to one embodiment. Operation 332 can occur at any time between operation 305 and operation 331, according to one embodiment. Operation 332 can occur before operation 305 and/or can occur after operation 331, according to one embodiment. In one embodiment, operation 324 and/or operation 326 apply the one or more predictive models that are trained and retrained in operation 332 to the received system access data to determine the risk scores, according to one embodiment. In one embodiment, the security system 304 trains and periodically re-trains one or more predictive models on a periodic basis (e.g., at the end of each business day), according to one embodiment. In one embodiment, the security system 304 trains new predictive models and/or re-trains existing predictive models based on a number of additional data samples (e.g., fraud data samples) that are acquired from the tax return preparation system 303, according to one embodiment. For example, the security system 304 is configured to train new predictive models and/or retrain existing predictive models after 10, 50, 100, etc. additional fraudulent activities are identified, to assist new predictive models in more accurately identifying subsequent cases of potential account takeover, according to one embodiment.

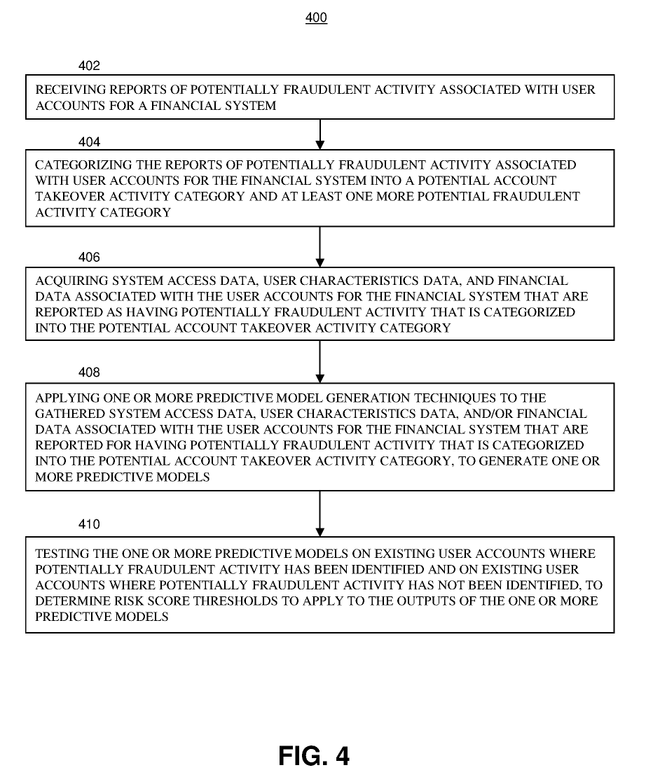

FIG. 4 illustrates an example flow diagram of a process 400 for training and/or retraining one or more predictive models to generate risk scores data representing one or more risk scores, at least partially based on system access data and/or the user characteristics data and/or financial data received and/or generated by a tax return preparation system and/or some other financial system, according to one embodiment. In one embodiment, the process 400 includes an algorithm for a means for training one or more predictive models, according to one embodiment. In one embodiment, the process 400 includes an algorithm for a means for training one or more predictive models to generate risk score data at least partially based on system access data, according to one embodiment.

At operation 402, the process includes receiving reports of potentially fraudulent activity associated with user accounts for a financial system, according to one embodiment. In one embodiment, receiving reports potentially fraudulent activity includes receiving reports from a customer service or customer care representative. In one embodiment, verified cases of fraudulent activity are stored in a database along with user account data and system access data that correspond with the verified cases of fraudulent activity. Operation 402 proceeds to operation 404, according to one embodiment.

At operation 404, the process includes categorizing the reports of potentially fraudulent activity associated with user accounts for the financial system into a potential account takeover activity category and at least one more potential fraudulent activity category, according to one embodiment. Operation 404 proceeds to operation 406, according to one embodiment.

At operation 406, the process includes acquiring system access data, user characteristics data, and financial data associated with the user accounts for the financial system that are reported as having potentially fraudulent activity that is categorized into the potential account takeover activity category, according to one embodiment. Operation 406 proceeds to operation 408, according to one embodiment.

At operation 408, the process includes applying one or more predictive model generation techniques to the gathered system access data, user characteristics data, and/or financial data associated with the user accounts for the financial system that are reported for having potentially fraudulent activity that is categorized into the potential account takeover activity category, to generate one or more predictive models, according to one embodiment. Operation 408 proceeds to operation 410, according to one embodiment.

At operation 410, the process includes testing the one or more predictive models on existing user accounts where potentially fraudulent activity has been identified and on existing user accounts where potentially fraudulent activity has not been identified, to determine risk score thresholds to apply to the outputs of the one or more predictive models, according to one embodiment.

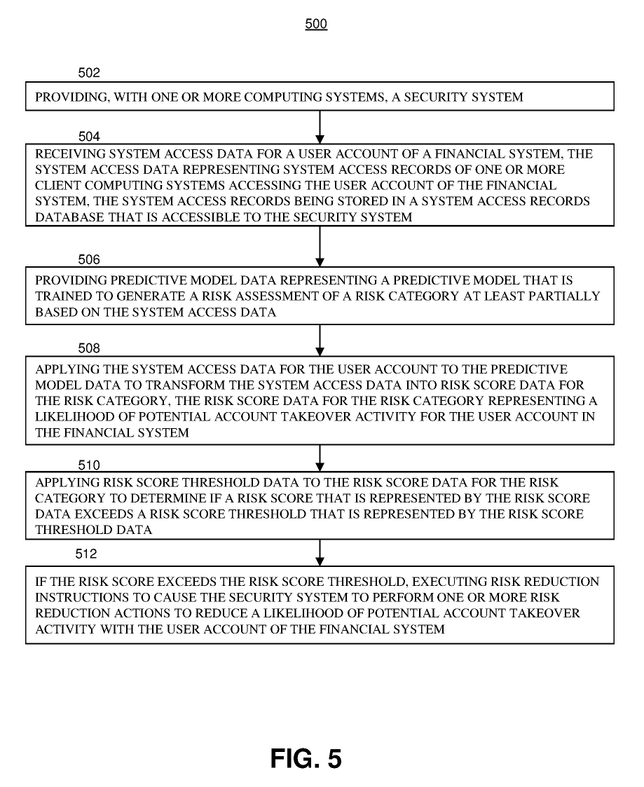

FIG. 5 illustrates an example flow diagram of a process 500 for identifying and addressing potential account takeover activities in a financial system, according to one embodiment.

At operation 502, the process includes providing, with one or more computing systems, a security system, according to one embodiment. Operation 502 proceeds to operation 504, according to one embodiment.

At operation 504, the process includes receiving system access data for a user account of a financial system, the system access data representing system access records of one or more client computing systems accessing the user account of the financial system, the system access records being stored in a system access records database that is accessible to the security system, according to one embodiment. The system access records (represented by the system access data) include browsing and/or navigation behavior of a client system within a user account for the financial system, according to one embodiment. The system access records include account modifications and information requests made by the client system within the user account for the financial system, according to one embodiment. Operation 504 proceeds to operation 506, according to one embodiment.

At operation 506, the process includes providing predictive model data representing a predictive model that is trained to generate a risk assessment of a risk category at least partially based on the system access data, according to one embodiment. Examples of risk categories include, but are not limited to, user system characteristics, IP address, and user account characteristics, according to one embodiment. Operation 506 proceeds to operation 508, according to one embodiment.

At operation 508, the process includes applying the system access data for the user account to the predictive model data to transform the system access data into risk score data for the risk category, the risk score data for the risk category representing a likelihood of potential account takeover activity for the user account in the financial system, according to one embodiment. A predictive model receives a first type of data and transforms or converts that first type of data into another type of data, according to one embodiment. As result, the predictive model transforms the system access data into risk score data by generating the risk score data in response to receiving the system access data, according to one embodiment. Operation 508 proceeds to operation 510, according to one embodiment.

At operation 510, the process includes applying risk score threshold data to the risk score data for the risk category to determine if a risk score that is represented by the risk score data exceeds a risk score threshold that is represented by the risk score threshold data, according to one embodiment. Operation 510 proceeds to operation 512, according to one embodiment.

At operation 512, if the risk score exceeds the risk score threshold, the process includes executing risk reduction instructions to cause the security system to perform one or more risk reduction actions to reduce a likelihood of potential account takeover activity with the user account of the financial system, according to one embodiment.

In one embodiment, the process 500 applies a system access data to multiple predictive models, with each of the predictive models generating a risk score for different risk categories, according to one embodiment. The risk scores of the multiple predictive models are individually compared to their own risk score thresholds, to determine if any of the risk categories exceed a corresponding risk score threshold, according to one embodiment. At operation 512, the process includes executing risk reduction instructions if any of the risk scores exceed their corresponding risk score thresholds, according to one embodiment. At operation 512, the process includes executing risk reduction instructions if the average, sum, or other normalized result of the risk scores exceeds a general risk score threshold, according to one embodiment.

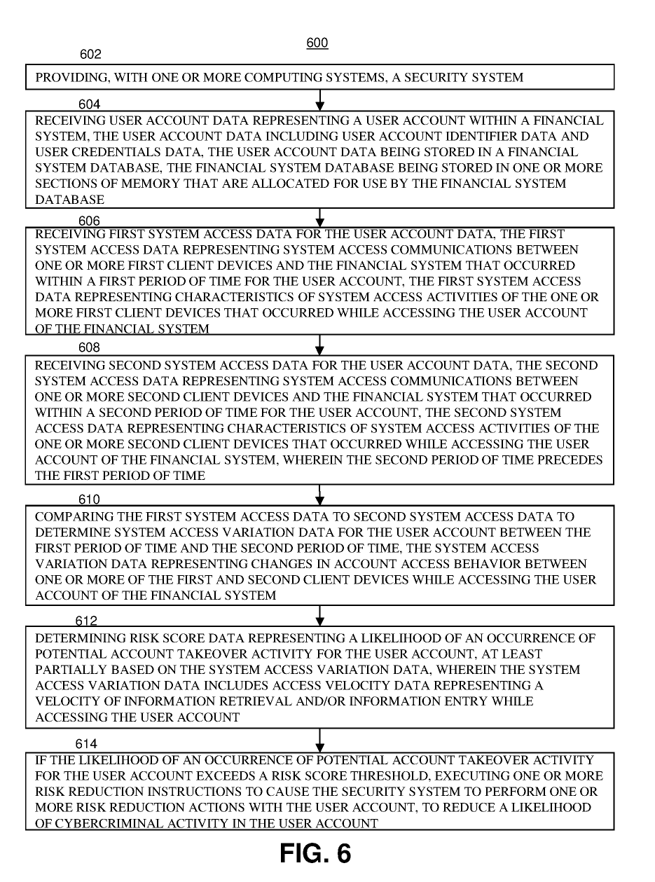

FIG. 6 illustrates an example flow diagram of a process 600 for identifying and addressing potential account takeover activities in a financial system, according to one embodiment.

At operation 602, the process includes providing, with one or more computing systems, a security system, according to one embodiment. Operation 602 proceeds to operation 604, according to one embodiment.

At operation 604, the process includes receiving user account data representing a user account within a financial system, the user account data including user account identifier data and user credentials data, the user account data being stored in a financial system database, the financial system database being stored in one or more sections of memory that are allocated for use by the financial system database, according to one embodiment. The security system receives the user account data from the financial system to identify which user account to analyze for potential account takeover activity, according to one embodiment. The security system may include access of the same databases as the financial system, so receiving the user account data enables the security system to query the database to acquire system access data for the user account data that is received by the security system, according to one embodiment. Operation 604 proceeds to operation 606, according to one embodiment.

At operation 606, the process includes receiving first system access data for the user account data, the first system access data representing system access communications between one or more first client devices and the financial system that occurred within a first period of time for the user account, the first system access data representing characteristics of system access activities of the one or more first client devices that occurred while accessing the user account of the financial system, according to one embodiment. The first system access data represents system access data that occurs during a session that is currently open or that occurs recently (e.g., within the last day, with the last week, etc.), according to one embodiment. The second system access data, described below, represents system access data that occurred previously, for example, during a previous year during one or more sessions that occurred in previous weeks, and previous months, etc., according to one embodiment. The first system access data is compared to the second system access data to determine changes in the navigation behavior and/or usage of the financial system, to facilitate determining whether or not a particular system access activities are potential account takeover activities, according to one embodiment. Operation 606 proceeds to operation 608, according to one embodiment.

At operation 608, the process includes receiving second system access data for the user account data, the second system access data representing system access communications between one or more second client devices and the financial system that occurred within a second period of time for the user account, the second system access data representing characteristics of system access activities of the one or more second client devices that occurred while accessing the user account of the financial system, wherein the second period of time precedes the first period of time, according to one embodiment. Operation 608 proceeds to operation 610, according to one embodiment.

At operation 610, the process includes comparing the first system access data to second system access data to determine system access variation data for the user account between the first period of time and the second period of time, the system access variation data representing changes in account access behavior between one or more of the first and second client devices while accessing the user account of the financial system, according to one embodiment. The variation data represents navigation behavior changes and other changes that may be indicative of a user account being accessed by someone other than the authorized user, according to one embodiment. Operation 610 proceeds to operation 612, according to one embodiment.

At operation 612, the process includes determining risk score data representing a likelihood of an occurrence of potential account takeover activity for the user account, at least partially based on the system access variation data, according to one embodiment. Operation 612 proceeds to operation 614, according to one embodiment.

At operation 614, if the likelihood of an occurrence of potential account takeover activity for the user account exceeds a risk score threshold, the process includes executing one or more risk reduction instructions to cause the security system to perform one or more risk reduction actions with the user account, to reduce a likelihood of cybercriminal activity in the user account, according to one embodiment.

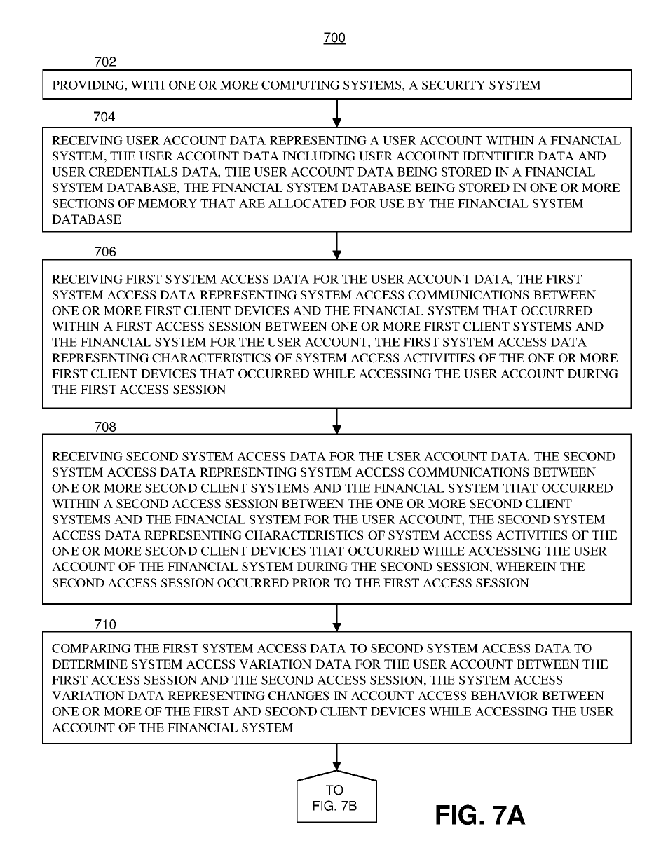

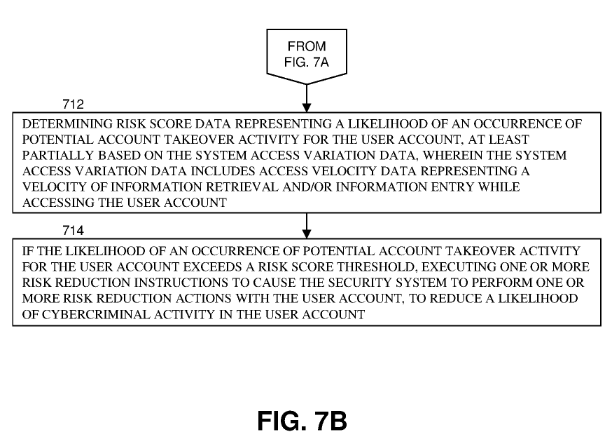

FIGS. 7A and 7B illustrate an example flow diagram of a process 700 for identifying and addressing potential account takeover activities in a financial system, according to one embodiment.

At operation 702, the process includes providing, with one or more computing systems, a security system, according to one embodiment. Operation 702 proceeds to operation 704, according to one embodiment.

At operation 704, the process includes receiving user account data representing a user account within a financial system, the user account data including user account identifier data and user credentials data, the user account data being stored in a financial system database, the financial system database being stored in one or more sections of memory that are allocated for use by the financial system database, according to one embodiment. Operation 704 proceeds to operation 706, according to one embodiment.

At operation 706, the process includes receiving first system access data for the user account data, the first system access data representing system access communications between one or more first client devices and the financial system that occurred within a first access session between one or more first client systems and the financial system for the user account, the first system access data representing characteristics of system access activities of the one or more first client devices that occurred while accessing the user account during the first access session, according to one embodiment. In one embodiment, the first access session is the most recent access session that has occurred for a user account with the financial system, according to one embodiment. For example, the first access session could be a session that is currently in progress, if the security system is analyzing system access data in real-time to provide real-time identification of potential account takeover activities, according to one embodiment. In one embodiment, the second access session includes one or more access sessions other than the most recent (i.e., last) session in which a client system access a particular user account, according to one embodiment. As a result, a comparison of the first access session in the second access session is a comparison of user behavior between different sessions with the financial system for a particular user account, according to one embodiment. Operation 706 proceeds to operation 708, according to one embodiment.

At operation 708, the process includes receiving second system access data for the user account data, the second system access data representing system access communications between one or more second client systems and the financial system that occurred within a second access session between the one or more second client systems and the financial system for the user account, the second system access data representing characteristics of system access activities of the one or more second client devices that occurred while accessing the user account of the financial system during the second session, wherein the second access session occurred prior to the first access session, according to one embodiment. Operation 708 proceeds to operation 710, according to one embodiment.

At operation 710, the process includes comparing the first system access data to second system access data to determine system access variation data for the user account between the first access session and the second access session, the system access variation data representing changes in account access behavior between one or more of the first and second client devices while accessing the user account of the financial system, according to one embodiment. Operation 710 proceeds to operation 712, according to one embodiment.

At operation 712, the process includes determining risk score data representing a likelihood of an occurrence of potential account takeover activity for the user account, at least partially based on the system access variation data, according to one embodiment. Operation 712 proceeds to operation 714, according to one embodiment.

At operation 714, if the likelihood of an occurrence of potential account takeover activity for the user account exceeds a risk score threshold, the process includes executing one or more risk reduction instructions to cause the security system to perform one or more risk reduction actions with the user account, to reduce a likelihood of cybercriminal activity in the user account, according to one embodiment.

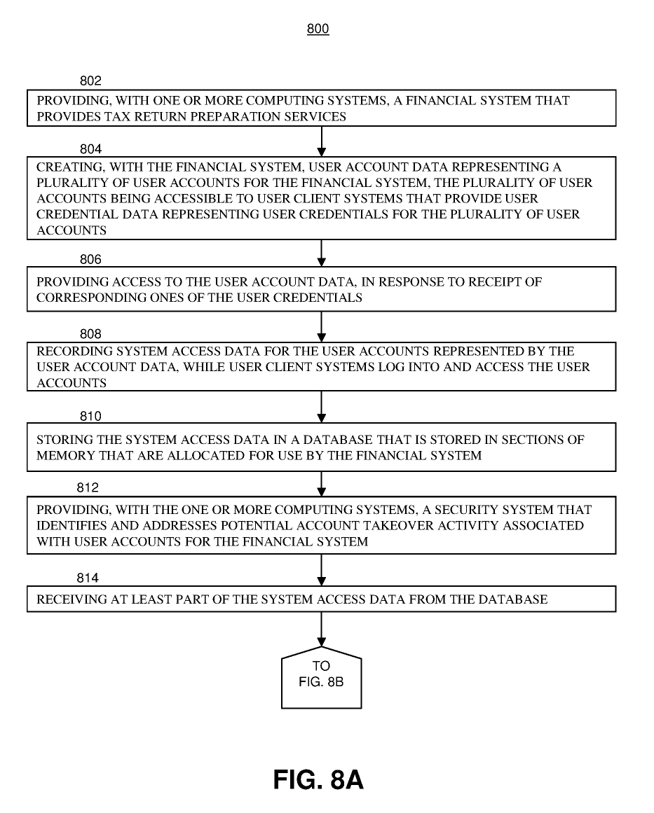

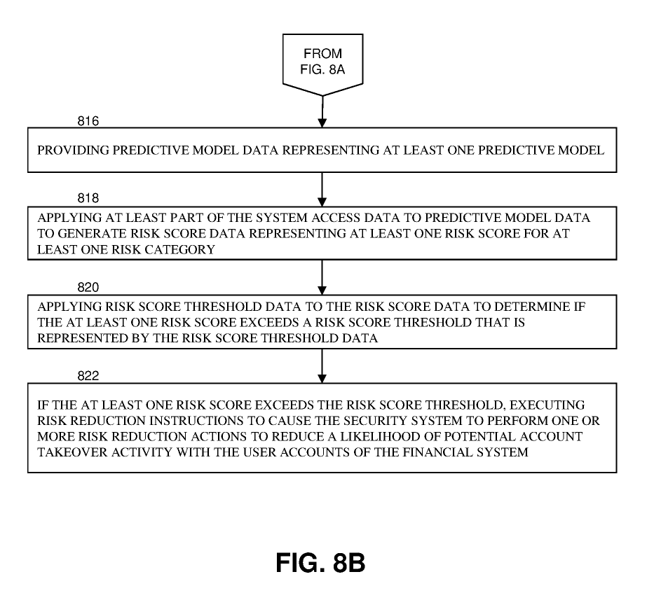

FIGS. 8A and 8B illustrate an example flow diagram of a process 800 for identifying and addressing potential account takeover activities in a financial system, according to one embodiment.

At operation 802, the process includes providing, with one or more computing systems, a financial system that provides tax return preparation services, according to one embodiment. Operation 802 proceeds to operation 804, according to one embodiment.

At operation 804, the process includes creating, with the financial system, user account data representing a plurality of user accounts for the financial system, the plurality of user accounts being accessible to user client systems that provide user credential data representing user credentials for the plurality of user accounts, according to one embodiment. Operation 804 proceeds to operation 806, according to one embodiment.

At operation 806, the process includes providing access to the user account data, in response to receipt of corresponding ones of the user credentials, according to one embodiment. Operation 806 proceeds to operation 808, according to one embodiment.

At operation 808, the process includes recording system access data for the user accounts represented by the user account data, while user client systems log into and access the user accounts, according to one embodiment. Operation 808 proceeds to operation 810, according to one embodiment.

At operation 810, the process includes storing the system access data in a database that is stored in sections of memory that are allocated for use by the financial system, according to one embodiment. Operation 810 proceeds to operation 812, according to one embodiment.

At operation 812, the process includes providing, with the one or more computing systems, a security system that identifies and addresses potential account takeover activity associated with user accounts for the financial system, according to one embodiment. Operation 812 proceeds to operation 814, according to one embodiment.

At operation 814, the process includes receiving at least part of the system access data from the database, according to one embodiment. In one embodiment, the databases is centralized and is accessible by the financial system and the security system. Operation 814 proceeds to operation 816, according to one embodiment.

At operation 816, the process includes providing predictive model data representing at least one predictive model, according to one embodiment. In one embodiment, the at least one predictive model includes at least one predictive model for each of a number of risk categories, which include, but are not limited to, user system characteristics, IP address, and user account. Operation 816 proceeds to operation 818, according to one embodiment.

At operation 818, the process includes applying at least part of the system access data to predictive model data to generate risk score data representing at least one risk score for at least one risk category, according to one embodiment. In one embodiment, each of the predictive models generates one risk score for one risk category, according to one embodiment. Operation 818 proceeds to operation 820, according to one embodiment.

At operation 820, the process includes applying risk score threshold data to the risk score data to determine if the at least one risk score exceeds a risk score threshold that is represented by the risk score threshold data, according to one embodiment. In one embodiment, each risk score for a particular risk category is assigned one risk score threshold to determine if the risk score for the particular risk category is indicative of potential account takeover activity for a user account. Operation 820 proceeds to operation 822, according to one embodiment.

At operation 822, if the at least one risk score exceeds the risk score threshold, the process includes executing risk reduction instructions to cause the security system to perform one or more risk reduction actions to reduce a likelihood of potential account takeover activity with the user accounts of the financial system, according to one embodiment.

As noted above, the specific illustrative examples discussed above are but illustrative examples of implementations of embodiments of the method or process for identifying and addressing potential account takeover activity in a financial system. Those of skill in the art will readily recognize that other implementations and embodiments are possible. Therefore the discussion above should not be construed as a limitation on the claims provided below.

By identifying and addressing potential fraudulent activity (e.g., account takeover) in a financial system, implementation of embodiments of the present disclosure allows for significant improvement to the fields of data security, financial systems security, electronic tax return preparation, data collection, and data processing, according to one embodiment. As illustrative examples, by identifying and addressing potentially fraudulent activity, fraudsters can be deterred from criminal activity, financial systems may retain/build trusting relationships with customers, customers may be spared financial losses, criminally funded activities may be decreased due to less or lack of funding, tax refunds may be delivered to authorized recipients faster (due to less likelihood of unauthorized recipients). As another example, by identifying and implementing risk reducing activities, tax filer complaints to the Internal Revenue Service (“IRS”) and to financial system service providers may be reduced. As a result, embodiments of the present disclosure allow for reduced communication channel bandwidth utilization, and faster communications connections. Consequently, computing and communication systems implementing and/or providing the embodiments of the present disclosure are transformed into faster and more operationally efficient devices and systems.

In addition to improving overall computing performance, by identifying and addressing potentially fraudulent activity in a financial system, implementation of embodiments of the present disclosure represent a significant improvement to the field of providing an efficient user experience and, in particular, efficient use of human and non-human resources. As one illustrative example, by identifying and addressing fraudulent activity in user accounts, users can devote less time and energy to resolving issues associated with account abuse. Additionally, by identifying and addressing potential account takeover activity in a financial system, the financial system maintains, improves, and/or increases the likelihood that a customer will remain a paying customer and advertise the received services to the customer's peers, according to one embodiment. Consequently, using embodiments of the present disclosure, the user's experience is less burdensome and time consuming and allows the user to dedicate more of his or her time to other activities or endeavors.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for identifying and addressing potential account takeover activity in a financial system, comprising:
providing, with one or more computing systems, a security system;
receiving system access data for a user account of a financial system, the system access data representing system access records of one or more client computing systems accessing the user account of the financial system, the system access records being stored in a system access records database that is accessible to the security system;
providing predictive model data representing a predictive model that is trained to generate a risk assessment of a risk category at least partially based on the system access data;
applying the system access data for the user account to the predictive model data to transform the system access data into risk score data for the risk category, the risk score data for the risk category representing a likelihood of potential account takeover activity for the user account in the financial system;
applying risk score threshold data to the risk score data for the risk category to determine if a risk score that is represented by the risk score data exceeds a risk score threshold that is represented by the risk score threshold data; and
if the risk score exceeds the risk score threshold, executing risk reduction instructions to cause the security system to perform one or more risk reduction actions to reduce a likelihood of potential account takeover activity with the user account of the financial system.

2. The computing system implemented method of claim 1, wherein the risk category is selected from a group of risk categories, consisting of:
user system characteristics;
user system characteristics identifier;
IP address;
IP address identifier;
user account; and
user account identifier.

3. The computing system implemented method of claim 2, wherein the user system characteristics identifier is generated at least partially based on an operating system of a client system, a web browser used by the client system to access the user account, and a hardware characteristic of the client system, wherein the IP address identifier is generated at least partially based on characteristics of the IP address, wherein the user account identifier is generated at least partially based on a username or password for the user account.

4. The computing system implemented method of claim 1, further comprising:
identifying user accounts of the financial system that have been accessed by unauthorized users;
requesting system access data for the user accounts of the financial system that have been accessed by the unauthorized users; and
applying a predictive model training operation to the system access data for the user accounts of the financial system that have been accessed by the unauthorized users, to generate a predictive model data and to train the predictive model.

5. The computing system implemented method of claim 1, further comprising:
generating receiver operating characteristics data representing a receiver operating characteristics of the predictive model; and
determining the risk score threshold at least partially based on the receiver operating characteristics of the predictive model and a quantity of false-negative errors that is indicated by the receiver operating characteristics.

6. The computing system implemented method of claim 1, wherein the predictive model transforms the system access data into the risk score data at least partially based on information requests, information submissions, and user experience navigation in the financial system.

7. The computing system implemented method of claim 1, wherein the predictive model transforms the system access data into the risk score data at least partially based on year-to-year changes of navigation behavior in the financial system.

8. The computing system implemented method of claim 1, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access the user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

9. The computing system implemented method of claim 1, wherein the one or more risk reduction actions includes alerting the financial system of the likelihood of potential account takeover activity with the user account, to enable the financial system to increase security for the user account.

10. The computing system implemented method of claim 1, wherein the one or more risk reduction actions are selected from a group of risk reduction actions, consisting of:
preventing a user from taking an action within the user account of the financial system;
preventing a user from logging into the user account;
increasing authentication requirements to access the user account in the financial system;
terminating a system access session for the user account;
notifying an authorized user of the user account of potential account takeover activity via email, text message, and/or a telephone call; and
requiring multifactor authentication to access the user account; and
removing multifactor authentication options to increase a difficulty of authentication for the user account.

11. A computing system implemented method for identifying and addressing potential account takeover activity in a financial system, comprising:
providing, with one or more computing systems, a security system;
receiving system access data for a user account of a financial system, the system access data representing system access records of one or more client computing systems accessing the user account of the financial system, the system access records being stored in a system access records database that is accessible to the security system;
providing predictive model data representing a first predictive model that is trained to generate a risk assessment of a first risk category at least partially based on the system access data, and representing a second predictive model that is trained to generate a risk assessment of a second risk category at least partially based on the system access data;
applying the system access data to the predictive model data to generate first risk score data for the first risk category from the first predictive model and second risk score data for the second risk category from the second predictive model, the first risk score data for the first risk category representing a first risk score that is a first likelihood of potential account takeover activity for the user account in the financial system, the second risk score data for the second risk category representing a second risk score that is a second likelihood of potential account takeover activity for the user account in the financial system;
applying first risk score threshold data to the first risk score data and second risk score threshold data to the second risk score data, the first risk score threshold data representing a first risk score threshold, the second risk score threshold data representing a second risk score threshold; and
if the first risk score exceeds the first risk score threshold, or if the second risk score exceeds the second risk score threshold, executing risk reduction instructions to cause the security system to perform one or more risk reduction actions to reduce a likelihood of potential account takeover activity with the user account of the financial system.

12. The computing system implemented method of claim 11, wherein the first risk category and the second risk category are selected from a group of risk categories, consisting of:
user system characteristics;
user system characteristics identifier;
IP address;
IP address identifier;
user account; and
user account identifier.

13. The computing system implemented method of claim 11, further comprising:
identifying user accounts of the financial system that have been accessed by unauthorized users;
requesting system access data for the user accounts of the financial system that have been accessed by the unauthorized users; and
applying a predictive model training operation to the system access data for the user accounts of the financial system that have been accessed by the unauthorized users, to generate the predictive model data and to train the first and second predictive models.

14. The computing system implemented method of claim 13, wherein the predictive model training operation is selected from a group of predictive model training operations, consisting of:
regression;
logistic regression;
decision trees;
artificial neural networks;
support vector machines;
linear regression;
nearest neighbor methods;
distance based methods;
naive Bayes;
linear discriminant analysis; and
k-nearest neighbor algorithm.

15. The computing system implemented method of claim 11, further comprising:
generating receiver operating characteristics data representing a receiver operating characteristics of the first predictive model; and
determining the first risk score threshold at least partially based on the receiver operating characteristics of the first predictive model and a quantity of false-negative errors that is indicated by the receiver operating characteristics.

16. The computing system implemented method of claim 11, wherein the predictive model data generates first risk score data for the first risk category by transforming at least part of the system access data into the first risk score data.

17. The computing system implemented method of claim 11, wherein the predictive model transforms the system access data into the risk score data at least partially based on changes to navigation behavior in the financial system between a first time period and a second time period.

18. The computing system implemented method of claim 11, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access the user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

19. The computing system implemented method of claim 11, wherein the one or more risk reduction actions includes alerting the financial system of the likelihood of potential account takeover activity with the user account, to enable the financial system to increase security for the user account.

20. The computing system implemented method of claim 11, wherein the one or more risk reduction actions are selected from a group of risk reduction actions, consisting of:
preventing a user from taking an action within the user account of the financial system;
preventing a user from logging into the user account;
increasing authentication requirements to access the user account in the financial system;
terminating a system access session for the user account;
notifying an authorized user of the user account of potential account takeover activity via email, text message, and/or a telephone call; and
requiring multifactor authentication to access the user account; and
removing multifactor authentication options to increase a difficulty of authentication for the user account.

21. A computing system implemented method for identifying and addressing potential account takeover activity in a financial system, comprising:
providing, with one or more computing systems, a security system;
receiving user account data representing a user account within a financial system, the user account data including user account identifier data and user credentials data, the user account data being stored in a financial system database, the financial system database being stored in one or more sections of memory that are allocated for use by the financial system database;
receiving first system access data for the user account data, the first system access data representing system access communications between one or more first client devices and the financial system that occurred within a first period of time for the user account, the first system access data representing characteristics of system access activities of the one or more first client devices that occurred while accessing the user account of the financial system;
receiving second system access data for the user account data, the second system access data representing system access communications between one or more second client devices and the financial system that occurred within a second period of time for the user account, the second system access data representing characteristics of system access activities of the one or more second client devices that occurred while accessing the user account of the financial system, wherein the second period of time precedes the first period of time;
comparing the first system access data to second system access data to determine system access variation data for the user account between the first period of time and the second period of time, the system access variation data representing changes in account access behavior between one or more of the first and second client devices while accessing the user account of the financial system;
determining risk score data representing a likelihood of an occurrence of potential account takeover activity for the user account, at least partially based on the system access variation data; and
if the likelihood of an occurrence of potential account takeover activity for the user account exceeds a risk score threshold, executing one or more risk reduction instructions to cause the security system to perform one or more risk reduction actions with the user account, to reduce a likelihood of cybercriminal activity in the user account.

22. The computing system implemented method of claim 21 wherein the first period of time is a period of time that is selected from a group periods of time, consisting of:
a preceding hour of time;
during a present day;
during a preceding day; and
a period of time from when a user most recently provided credentials data to the financial system to obtain access to the user account, until a present time.

23. The computing system implemented method of claim 21 wherein the second period of time is a period of time that is selected from a group periods of time, consisting of:
a period of time from a creation time of the user account until a present time;
a prior year;
a prior tax season; and
a period of time from a creation time of the user account until a penultimate access of the user account.

24. The computing system implemented method of claim 21, wherein comparing the first system access data to the second system access data includes applying the first system access data to a predictive model that is trained with the second system access data to generate the risk score data.

25. The computing system implemented method of claim 21, wherein the first system access data and the second system access data are selected from a group of system access data, consisting of:
data representing features or characteristics associated with an interaction between a client system and the financial system;
data representing a web browser of a client system;
data representing an operating system of a client system;
data representing a media access control address of the client system;
data representing user credentials used to access the user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

26. The computing system implemented method of claim 21, wherein the one or more risk reduction actions includes alerting the financial system of the likelihood of occurrence of potential account takeover activity for the user account, to enable the financial system to increase security for the user account.

27. The computing system implemented method of claim 21, wherein the one or more risk reduction actions are selected from a group of risk reduction actions, consisting of:
preventing a user from taking an action within the user account of the financial system;
preventing a user from logging into the user account;
increasing authentication requirements to access the user account in the financial system;
terminating a system access session for the user account;
notifying an authorized user of the user account of potential account takeover activity via email, text message, and/or a telephone call; and
requiring multifactor authentication to access the user account; and
removing multifactor authentication options to increase a difficulty of authentication for the user account.

28. A computing system implemented method for identifying and addressing potential account takeover activity in a financial system, comprising:
providing, with one or more computing systems, a security system;
receiving user account data representing a user account within a financial system, the user account data including user account identifier data and user credentials data, the user account data being stored in a financial system database, the financial system database being stored in one or more sections of memory that are allocated for use by the financial system database;
receiving first system access data for the user account data, the first system access data representing system access communications between one or more first client devices and the financial system that occurred within a first access session between one or more first client systems and the financial system for the user account, the first system access data representing characteristics of system access activities of the one or more first client devices that occurred while accessing the user account during the first access session;
receiving second system access data for the user account data, the second system access data representing system access communications between one or more second client systems and the financial system that occurred within a second access session between the one or more second client systems and the financial system for the user account, the second system access data representing characteristics of system access activities of the one or more second client systems that occurred while accessing the user account of the financial system during the second session, wherein the second access session occurred prior to the first access session;
comparing the first system access data to second system access data to determine system access variation data for the user account between the first access session and the second access session, the system access variation data representing changes in account access behavior between one or more of the first and second client systems while accessing the user account of the financial system;
determining risk score data representing a likelihood of an occurrence of potential account takeover activity for the user account, at least partially based on the system access variation data; and
if the likelihood of an occurrence of potential account takeover activity for the user account exceeds a risk score threshold, executing one or more risk reduction instructions to cause the security system to perform one or more risk reduction actions with the user account, to reduce a likelihood of cybercriminal activity in the user account.

29. The computing system implemented method of claim 28, wherein comparing the first system access data to the second system access data includes applying the first system access data to a predictive model that is at least partially trained with the second system access data.

30. The computing system implemented method of claim 28, wherein the system access variation data includes data representing changes in the characteristics of the system access activities from a first period of time to a second period of time.

31. The computing system implemented method of claim 28, wherein the one or more risk reduction instructions are selected from a group of risk reduction instructions, consisting of:
instructions that cause the security system to reduce multifactor authentication options available for accessing the user account;
instructions that cause the security system to add multifactor authentication requirements to accessing the user account;
instructions that cause the security system to notify an authorized user of the user account of access history for the user account;
instructions that cause the security system to notify a government agency of potentially fraudulent activity occurring for the user account;
instructions that cause the security system to block one or more particular activities within the financial system for the user account; and
instructions that cause the security system to at least temporarily deny access to the user account.

32. The computing system implemented method of claim 28, wherein determining risk score data includes determining the risk score data periodically.

33. The computing system implemented method of claim 32, wherein determining the risk score data periodically includes determining the risk score for the user account each day the user account is accessed by one or more of the first client systems, by one or more of the second client systems, or by one or more additional client systems.

34. The computing system implemented method of claim 28, wherein the first system access data and the second system access data are selected from a group of system access data, consisting of:
data representing features or characteristics associated with an interaction between a client system and the financial system;
data representing a web browser of a client system;
data representing an operating system of a client system;
data representing a media access control address of the client system;
data representing user credentials used to access the user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

35. A computing system implemented method for identifying and addressing potential account takeover activity in a financial system, comprising:
providing, with one or more computing systems, a financial system that provides tax return preparation services;
creating, with the financial system, user account data representing a plurality of user accounts for the financial system, the plurality of user accounts being accessible to user client systems that provide user credential data representing user credentials for the plurality of user accounts;
providing access to the user account data, in response to receipt of corresponding ones of the user credentials;
recording system access data for the user accounts represented by the user account data, while user client systems log into and access the user accounts;
storing the system access data in a database that is stored in sections of memory that are allocated for use by the financial system;
providing, with the one or more computing systems, a security system that identifies and addresses potential account takeover activity associated with user accounts for the financial system;
receiving at least part of the system access data from the database;
providing predictive model data representing at least one predictive model;
applying at least part of the system access data to predictive model data to generate risk score data representing at least one risk score for at least one risk category;
applying risk score threshold data to the risk score data to determine if the at least one risk score exceeds a risk score threshold that is represented by the risk score threshold data; and
if the at least one risk score exceeds the risk score threshold, executing risk reduction instructions to cause the security system to perform one or more risk reduction actions to reduce a likelihood of potential account takeover activity with the user accounts of the financial system.

36. The computing system implemented method of claim 35, wherein the at least one risk category is selected from a group of risk categories, consisting of:
user system characteristics;
user system characteristics identifier;
IP address;
IP address identifier;
user account; and
user account identifier.

37. The computing system implemented method of claim 35, further comprising:
identifying user accounts of the financial system that have been accessed by unauthorized users;
requesting system access data for the user accounts of the financial system that have been accessed by the unauthorized users; and
applying a predictive model training operation to the system access data for the user accounts of the financial system that have been accessed by the unauthorized users, to generate the predictive model data and to train the at least one predictive model.

38. The computing system implemented method of claim 35, wherein the system access data is selected from a group of system access data consisting of:
data representing features or characteristics associated with an interaction between a client system and the financial system;
data representing a web browser of a client system;
data representing an operating system of a client system;
data representing a media access control address of the client system;
data representing user credentials used to access the user account;
data representing a user account;
data representing a user account identifier;
data representing interaction behavior between a client system and the financial system;
data representing characteristics of an access session for the user account;
data representing an IP address of a client system; and
data representing characteristics of an IP address of the client system.

39. The computing system implemented method of claim 35, wherein the one or more risk reduction actions includes alerting the financial system of the likelihood of potential account takeover activity with the user account, to enable the financial system to increase security for the user account.

40. The computing system implemented method of claim 35, wherein the one or more risk reduction actions are selected from a group of risk reduction actions, consisting of:
preventing a user from taking an action within the user account of the financial system;
preventing a user from logging into the user account;
increasing authentication requirements to access the user account in the financial system;
terminating a system access session for the user account;
notifying an authorized user of the user account of potential account takeover activity via email, text message, and/or a telephone call; and
requiring multifactor authentication to access the user account; and
removing multifactor authentication options to increase a difficulty of authentication for the user account.

41. The computing system implemented method of claim 35, wherein the at least one predictive model generates risk score data at least partially based on user characteristics data, the user characteristics data being selected from a group of user characteristics data, consisting of:
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.
